(19) United States
(12) Patent Application Publication
(10) Pub. No.: US 2007/0239948 A1
(43) Pub. Date: Oct. 11, 2007

(54) Data processor

(76) Inventors: Kenji Muraki, Katano-shi (JP); Hideshi Ishihara, Katano-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/303,888

(22) Filed: Dec. 16, 2005

(30) Foreign Application Priority Data
Dec. 17, 2004 (JP) 2004-365725

(51) Int. Cl. G06F 12/16

(52) U.S. Cl. 711/162

(57) ABSTRACT

A data processor includes: a first medium on which a content's data has been bound-recorded; a memory having stored thereon the content's access control information; and a read/write section for reading and writing data from/on a second medium. In response to a request to back up the content, the read/write section writes the content's data on the second medium and the memory retains the access control information without modifying the information. If a request to restore the content has been received and if the access control information that makes the content accessible is stored in the memory and if the content's data has been written on the second medium, then the read/write section reads the content's data from the second medium and writes the data on the first medium.

### BACKGROUND OF THE INVENTION

1. Field of the Invention

The present invention relates to a technique of backing up a content and a technique of moving the content.

2. Description of the Related Art

Recently, more and more contents are provided as digital ones. For example, BS, CS, terrestrial and CATV programs inside and outside Japan are transmitted in digital format. And those programs can be recorded digitally on tapes, disks and so on.

A digital transmission or digital recording realizes a higher density by compression techniques than an analog transmission or analog recording. For example, by using a radio wave allocated to a single channel of analog telecasts, standard quality digital video data on three channels can be transmitted. In this case, the analog telecasts are supposed to have standard quality and adopt an interlaced scanning technique using 480 effective scanning lines (480i).

Alternatively, high quality digital video data may also be transmitted by using a radio wave allocated to a single channel of analog telecasts. As used herein, the “high quality” may refer to a progressive scanning technique using 480 effective scanning lines (480p), a progressive scanning technique using 720 effective scanning lines (720p) or an interlaced scanning technique using 1,080 effective scanning lines (1,080i).

By adopting digital compression, audio data on 5.1 channels can also be transmitted. The 5.1 channels consist of five channels in right front, center front, left front, right rear and left rear and a bass sound channel, of which the frequency band is about one-tenth (0 to 200 Hz) as wide as that of those five channels. The latter is counted as 0.1 channels.

On top of that, as a result of such development in digital transmission technologies, not only video/audio data but also characters, control information, programs and so on can be transmitted now. Thus, the users can enjoy digital transmissions quite differently from analog ones.

A digital content is digital data, and therefore, can be copied without debasing its quality unlike an analog one. However, unlimited copying of a content would infringe the copyright of the content's author. That is why a digital recorder is now required to have a copyright protection function.

For example, in BS, broadband CS and terrestrial digital broadcasting within Japan, a content to be protected must be protected in accordance with the ARIB standard. That is to say, if a content, which should be protected in a form specified by a digital copy control descriptor and a content availability descriptor that are included in an MPEG-TS stream to be broadcast, is bound-recorded in a bound recording medium (such as a hard disk drive or a semiconductor memory) that is built in a receiver, the content needs to be processed (e.g., encrypted) so as to be playable only by that device.

A content may be backed up. However, if the backup content were restorable or playable by another device an unlimited number of times, various inconveniences would be caused. That is why the backup content should be made restorable only by that device and non-restorable and non-playable by another device.

Also, a content that has been broadcast as “copy one generation” is bound-recorded and updated into “copy never”. A “copy never” content may be moved to only one storage medium authorized by the ARIB standard. The “move” is a process of copying a content from a source to a destination and then making the content on the source non-playable.

For example, Japanese Patent Application Laid-Open Publication No. 2001-166999 discloses a method of backing up a content. According to this backup method, a “copy never” music or video content that has been purchased legally and then bound-recorded on an HDD or any other bound recording medium can be backed up while the “copy never” concept respected.

In the conventional backup method, two storage media with their own identification information are used. The original data recorded on a first storage medium can be backed up in the following procedure. First, first encrypted information recorded on the first storage medium is read. The first encrypted information has been encrypted based on the identification information (ID1) assigned to the first storage medium. Then, the first encrypted information read is further encrypted based on the identification information (ID2) assigned to a second storage medium as a backup, thereby generating second encrypted information. The second encrypted information is recorded on the second storage medium.

The backed up data may be restored in the following procedure. First, the second encrypted information is read from the second storage medium. The second encrypted information is decoded based on the identification information of the second storage medium, thereby restoring the first encrypted information. That first encrypted information is recorded on the first storage medium. Thereafter, when the first and second storage media are both authenticated as authorized storage media, the user is allowed to read the encrypted information from the first and second storage media.

The data that has been read from the second storage medium is demodulated and then decoded based on the identification information of the second storage medium. The decoded information, i.e., the information that has been encrypted with the first storage medium's own identification information, is written on the first storage medium. In this manner, the information that has been encrypted with only the identification information of the first storage medium has been written on the first storage medium. These read and write operations are carried out by making mutual authentication, and therefore, no illegal copies have been made.

As a result of these processing steps, the state that only one “copy never” content is available is maintained and its copyright is protected appropriately.

Move processing is subject to some attacks that are attempted to invalidate the copyright protection. As such attacks, save/restore attack, replay attack and other attacks are known. This attack is carried out according to the following principle. First, before the user moves a content, he or she backs up the content. Then, he or she carries out regular move processing. As a result, the content on the source of the move processing becomes non-playable. Thereafter, the user restores the backed up content to the source. Then, the content on the source becomes playable again. Naturally, the content that has been moved by the regular move processing is also playable. If the user carries out this operation repeatedly, then an unlimited number of “copy never” contents can be duplicated from a single “copy never” content. That is to say, the “copy never” content becomes substantially duplicable.

Thus, Japanese Patent Application Laid-Open Publication No. 2002-63074 discloses a move method that can repel such a save/restore attack.

According to the move method, either a content or access control information (i.e., a content availability management table) that is saved on a storage medium is bound on the storage medium in accordance with the information in a security area provided on the storage medium. Thereafter, when the content on the storage medium is moved, the information in the security area is rewritten and either the content or the access control information is bound all over again. And only if the information in the security area has the same value as the bound one, the bound information is validated. But if the information in the security area has a different value from the bound one, then the bound information is invalidated.

According to this method, the information in the security area changes and either the content or the content availability management table is bound all over again as a result of the move. That is why even if a content on a storage medium or the access control information thereof were backed up before the content on the storage medium is moved to another storage medium, the backup content would be non-playable when restored to the original storage medium. This is because an unbinding error would happen in that case. Consequently, the content can be moved between the storage media with the save/restore attack repelled.

According to this processing that is designed so as to repel the save/restore attack, however, no content backup is permitted. That is why if the bound recording medium were damaged for some reason, then even the content that was purchased legally by the user could not be reconstructed, which would be unbeneficial for him or her.

In addition, if no backup is permitted, then other problems will arise, too. Specifically, a digital broadcast content generally has a huge data size and a bound recording medium has only a limited bound recording capacity. Under the circumstances such as these, it is still impractical to save such a huge content for a long time. That is why such a content is preferably backed up on another storage medium and made ready to delete from the bound recording medium. For that purpose, backup is required.

The storage medium to which the content is either backed up or moved preferably can record an MPEG-TS content thereon in its original format. This is because the content can maintain its high quality and because various sorts of control information can be stored for the purpose of copyright protection. However, even if the content is down-converted to standard quality, the content could preferably be backed up or moved to another inexpensive storage medium such as a DVD.

It should be noted that the copyright protection might sometimes be restricted according to the recording format of the storage medium to which the content is either backed up or moved. For example, if the storage medium is a DVD, a stream in the MPEG-PS format on the DVD cannot store various types of control information that is included in a digital broadcast MPEG-TS for the purpose of copyright protection. Accordingly, if a DVD is used as a destination storage medium of the move processing, the details of the various types of control information will not be reflected, which is a problem.

### SUMMARY OF THE INVENTION

An object of the present invention is to back up a given content as a device's own content with the “copy one generation” content protection rules followed but without being restricted by the capacity of the bound recording medium.

A data processor according to the present invention includes: a first medium on which a content's data has been bound-recorded; a memory having stored thereon access control information to be used for controlling access to the content; an interface section that receives a request concerning the access to the content; and a read/write section for writing data on a second medium and reading the data that has been written on the second medium. If the interface section has received a request to back up the content, the read/write section writes the content's data on the second medium and the memory retains the access control information without modifying the information. If the interface section has received a request to restore the content and if the access control information that makes the content accessible is stored in the memory and if the content's data has been written on the second medium, then the read/write section reads the content's data from the second medium and writes the data on the first medium.

The data processor may further include a bound recording processing section for erasing data from the first medium. If the interface section has received a request to erase the content, the bound recording processing section may erase the content's data and the memory may retain the access control information without modifying the information.

The data processor may further include a control section for changing details of the access control information. The bound recording processing section may be able to read the data from the first medium. If the interface section has received a request to move the content and if the access control information that makes the content accessible is stored in the memory, then the bound recording processing section may read the content's data from the first medium and output the data. The control section may change the access control information into information that does not permit access to the content, may store the information in the memory, and may write the content's data either on the second storage medium or on a third storage medium that is provided separately from the second storage medium.

The content's data may have been encrypted so as to be decodable with its own decoding information. If the decoding information is stored as the access control information in the memory, then the read/write section may read the encrypted data from the second medium and may write the data on the first medium.

The data processor may further include a control section for changing the details of the access control information. The bound recording processing section may be able to read the data from the first medium. If the interface section has received a request to move the content and if the decoding information is stored as the access control information in the memory, then the bound recording processing section may read the content's data from the first medium and output the data. And the control section may make the decoding information not available, and may write the content's data on either the second storage medium or on a third storage medium that is provided separately from the second storage medium.

The data processor may further include a decoding section for decoding the content's data in accordance with the decoding information. The content's data that has been decoded by the decoding section may be written on the second storage medium and/or on the third storage medium that is provided separately from the second storage medium.

If the interface section has received a request to bound-record a content, then the bound recording processing section may generate access control information, which is associated with a new content and which makes the new content accessible, and write the new content's data on the first medium.

The content's data may include copy control information that prohibits re-copying.

The memory may have stored thereon access control information that specifies the accessibility count of a content. If the interface section has received a request to check out the content and if access control information that shows that the accessibility count is at least one is stored in the memory, then the read/write section may write the content's data on the second medium and the memory may store access control information showing that the accessibility count has decreased by one. But if the interface section has received a request to check in the content, then the read/write section may make the content's data that has been written on the second medium not available, and the memory may store access control information showing that the accessibility count has increased by one.

The data processor may further include a bound recording processing section for erasing data from the first medium. If the interface section has received a request to erase the content, the bound recording processing section may erase the content's data and the memory may retain the access control information without modifying the information.

According to the present invention, a content can be backed up and restored with its copyright protected. More specifically, in the processing of backing up a content, access control information for controlling access to the content is retained as it is. In the restore processing, on the other hand, the content is restored only when there is access control information that shows the content is accessible. Only the device that has carried out the backup processing can restore the content. That is why no data will be backed up by a device and then restored by another. Consequently, the copyright of a given content can be protected securely.

Also, once a content has been moved, the details of the access control information are changed such that no access to the content is permitted, and then the access control information will be retained as it is after that. That is why even if a malicious user has backed up a content to attempt a save/restore attack, the content will no longer be restorable once the content has been moved. Consequently, the save/restore attack can be fended off effectively.

The data processor of the present invention can not only bound-record a content using a dedicated device without being limited by the capacity of its bound recording medium but also move the content to a medium, which is also playable by another device, while following the “copy one generation” content protection rule.

### BRIEF DESCRIPTION OF THE DRAWINGS

FIGS. 1A through 1D show concepts of the processing of the present invention.

FIG. 2 shows a hardware configuration for a DVD recorder 101 with a built-in HDD.

FIG. 3 shows an arrangement of functional blocks in a recorder 101 according to a first preferred embodiment.

FIG. 4 shows an arrangement of functional blocks in the digital broadcasting receiving section 102.

FIG. 5 shows, in part (a), an exemplary data structure of a copy status descriptor and shows, in part (b), the details of the Private_data_byte field in the management information.

FIGS. 6A through 6G show values that can be set in the respective fields of the Private_data_byte field and their meanings.

FIG. 7 shows how the copyright protection information defines the bound recording operation and the operation of digitally recording or moving a content onto a removable storage medium.

FIG. 8 shows an arrangement of functional blocks in the bound recording processing section 103.

FIG. 9 shows more detailed configurations for the encryption section 1201 and the decoding section 1203.

FIG. 10 shows a configuration for encrypting and decoding a content by a method that requires unique decoding information for each single content.

FIG. 11 shows a configuration that adopts a method of deterring alteration using a check value.

FIG. 12A shows an exemplary piece of permission information.

FIG. 12B shows the number of accessibility flags and effective pieces of content identification information.

FIG. 13 shows an arrangement of functional blocks in the code processing section 113.

FIG. 14 shows an exemplary data structure of the management information file 1711.

FIG. 15 is a flowchart showing the procedure of operating the recorder 101.

FIG. 16 shows an arrangement of functional blocks in the user interface section 112.

FIG. 17 shows an exemplary timetable screen.

FIG. 18 shows an exemplary screen displayed for a playback manipulation purpose.

FIG. 19 shows an exemplary screen displayed for a move manipulation purpose.

FIG. 20 shows an exemplary screen displayed for an erase manipulation purpose.

FIG. 21 shows an exemplary screen displayed for a backup manipulation purpose.

FIG. 22 shows an exemplary screen displayed for a restore manipulation purpose.

FIG. 23 shows an arrangement of functional blocks in a recorder 101 according to a second preferred embodiment FIG. 24 shows a more detailed configuration for the encryption section 2401 and the decoding section 2403.

FIG. 25 shows a table with which multiple items of decoding information 2404 are registered.

FIG. 26 shows a configuration that adopts an alteration deterring method using a check value.

FIG. 27 shows an arrangement of functional blocks in a recorder 101 according to another preferred embodiment.

FIG. 28 shows more detailed configurations for the memory 106, second read/write section 3203 and third storage medium 3203.

FIG. 29 shows an exemplary screen displayed for a permission information backup manipulation purpose.

FIG. 30 shows an exemplary screen displayed for a permission information restore manipulation purpose.

FIG. 31 shows a configuration for backing up and restoring the decoding information 2404 onto the third storage medium 3203.

FIG. 32 shows an exemplary configuration for backing up the permission information on the first storage medium 109.

FIG. 33 shows an exemplary configuration for moving a content onto the first storage medium 109 and for backing up the permission information 2404 and the encrypted content on the bound recording medium 104 onto the first storage medium 109.

FIG. 34 shows a modified configuration for the code processing section 113 shown in FIG. 13.

FIG. 35 shows an example in which the bound recording medium 104 shown in FIG. 3 is arranged outside.

FIG. 36 shows detailed configurations for the media authenticating section 4002 and device authenticating section 4003.

FIG. 37 shows an arrangement of functional blocks for a recorder 101 and a second storage medium 2802 that realize a backup by mutual authentication.

FIG. 38 shows a modified example of the accessibility information.

### DETAILED DESCRIPTION OF PREFERRED EMBODIMENTS

Hereinafter, preferred embodiments of the present invention will be described with reference to the accompanying drawings. First, some key terms used in this description will be defined. Next, the basic idea of the present invention will be described. Then a hardware configuration to be applicable in common to the data processors of various preferred embodiments of the present invention will be described.

### A. Definitions of Terms

To store means writing data on a medium with either a storage area or a storage device and retaining that data such that the data is readily readable from the medium.

To record means storing data on a storage medium such that the data can be presented using a predetermined player. As used herein, the “predetermined player” includes not only the device that was used to record that data but also other devices with a playback function. Also, the “storage medium” is removable from the recorder and has such a shape as readily recognizable independently of that recorder. Examples of those storage media include magnetic tapes, optical disks, removable hard disks and semiconductor storage media.

To bound record means getting data stored on a storage medium by a device such that the data can be presented only with that device. In this case, the “storage medium” is supposed to be a built-in storage medium that is not usually removable (e.g., a built-in hard disk or a built-in semiconductor memory). For example, if content's data is stored by a device on a storage medium (e.g., on a built-in hard disk) after having been encrypted such that the data can be decoded only by that device, then that data is “bound-recorded”. However, data can be “bound-recorded” even on a removable storage medium as long as this definition is applicable.

To copy means copying data, which is stored on one storage medium, to another storage medium and storing it there.

To move means transferring data, which is currently stored on one storage medium, to another storage medium and storing it there. If no copying is permitted from one storage medium to another (i.e., if “copy never”), then the data stored on the source storage medium is no longer playable but only the data stored on the destination storage medium is playable once the move is completed. The data has been “moved” from the source storage medium to the destination storage medium as long as the data is no longer available from the source storage medium, no matter whether that data remains in the source storage medium or not. For example, if “copy never” content data stored on a storage medium is copied to another storage medium and then made not playable, then the content has been “moved”.

The “data” to be recorded, bound-recorded, copied or moved includes not only content's data but also management information for controlling the playback of that content. The content's data and management information are managed as separate files on the file system of each storage medium.

### B. Concept of the Present Invention

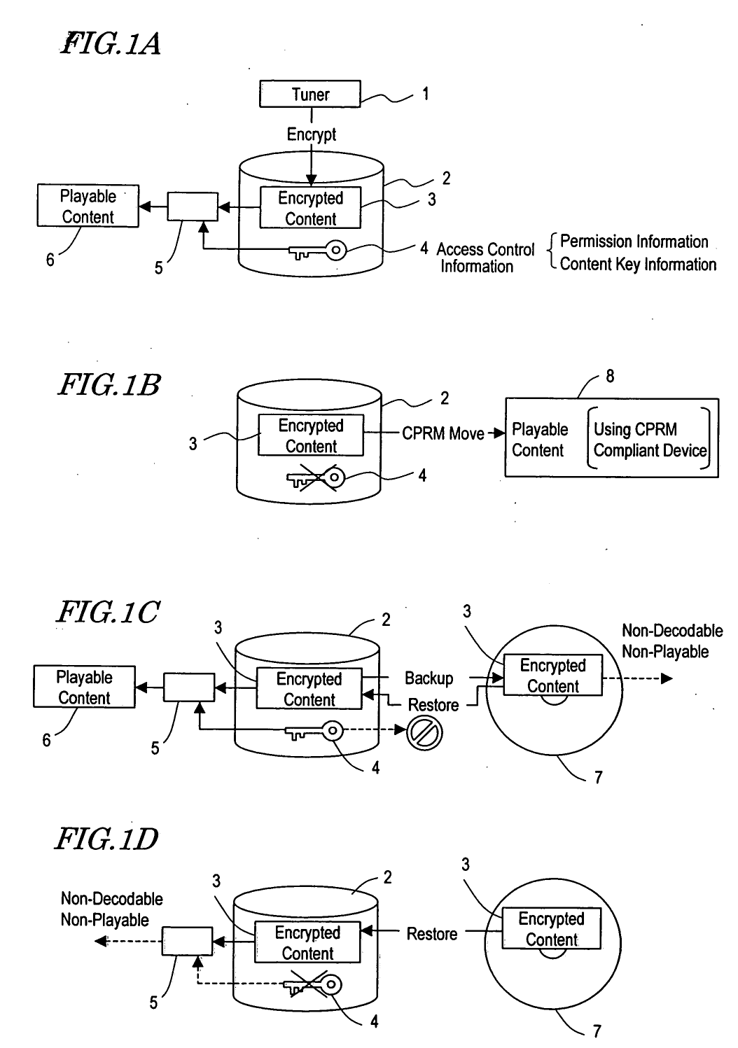

FIGS. 1A through 1D show the concepts of processing according to the present invention. According to the present invention, a content can be bound-recorded, played back, moved, backed up and restored with its copyright protected.

FIG. 1A shows how a given content is bound-recorded and played back according to a principle of the present invention. The content is supposed to be a digital broadcast program. A “copy one generation” content that has been received at a tuner 1 is updated into “copy never”, encrypted, and then bound-recorded as an encrypted content 3 in a device 2. At this point in time, access control information 4 is also generated within the device 2. This information may be stored in the internal memory of the device 2, for example, so as not to be altered externally.

The access control information 4 is used to control the access to a content. As used herein, the “access” to a content means playing or moving the content. “To control” the access to the content means either permitting or prohibiting the playback or move of the content. If the content that has come from the tuner 1 is bound-recorded, then a value that permits playback is set.

In the preferred embodiments to be described later, the access control information 4 is implemented as permission information and content key information (or decoding information). The permission information is permission-related information that shows whether the access to a given content is permitted or not. On the other hand, the content key information is decoding-related information that shows whether the encrypted content may be decoded or not.

The encrypted content 3 is playable depending on the access control information 4. If the access control information 4 permits playback, then a decision block 5 permits playback and a playable content 6 is output. It should be noted that the decision block 5 is actually provided within the device 2.

FIG. 1B shows how a content is moved according to a principle of the present invention. The encrypted content 3 that is bound-recorded in the device 2 may be moved to another storage medium (such as a DVD) only when the permission information of that content shows that the content can be accessed.

The move may be made so as to comply with the Copy Protection Right Management (CPRM) standard, for example. The moved content will become a content 8 that is playable by another device that complies with the CPRM standard.

As a result of the move, the access control information 4 associated with the content is invalidated. The “invalidation” may be done in any of various manners. As to the permission information to be described later, for example, the “invalidation” means changing the information into a value that prohibits the access to that content. As to the content key information (or decoding information) on the other hand, the “invalidation” means either deleting the information itself or changing its content into a non-decodable value.

FIG. 1C shows how a content is backed up and restored according to a principle of the present invention. The encrypted content 3 that is bound-recorded in the device 2 may be backed up on another storage medium (e.g., a storage medium 7 in this example). In that case, the access control information 4 is retained as it is in the device 2 without being modified. The access control information 4 is bound on the device 2 and therefore is not recorded on the storage medium 7, either.

The encrypted content 3 on the storage medium 7 is not playable by a different player. This is because only the device 2 that has made the backup can decode the encrypted content 3.

Meanwhile, after the content has been backed up, the encrypted content 3 in the device 2 may be either erased or have its data destroyed. In that case, the access control information 4 is not changed but only the data of the encrypted content 3 is erased from the device 2.

If the encrypted content 3 has been backed up, then the encrypted content 3 that has been recorded on the storage medium 7 can be restored after the encrypted content 3 has been erased from the device 2. Even if the content is restored, the access control information 4 is not changed, either.

Once the content has been restored, the device 2 can control its access in accordance with the access control information 4. Accordingly, if the access control information 4 shows that the content is playable, then the decision block 5 permits its playback and the playable content 6 is output.

FIG. 1D shows how the playback of an illegally restored encrypted content 3 is prohibited according to a principle of the present invention. For example, suppose an encrypted content 3 that has been restored by another device is now stored on the storage medium 7.

In that case, even if the encrypted content 3 is restored to the device 2 by the same method as that shown in FIG. 1C, no access control information 4 associated with the content is present in the device 2 and the decision block 5 never permits the playback of the encrypted content 3 with no access control information 4. This is because the decision block 5 acts in accordance with the access control information 4.

According to these principles, a given content can be backed up with the access to the content that has been either backed up or moved by a save/restore attack strictly prohibited.

Hereinafter, a configuration for an apparatus that puts these principles of the present invention into practice and its operation will be outlined.

### C. Hardware Configuration for Data Processor

In this description, a preferred embodiment of a data processor will be described as a DVD recorder including a built-in hard disk drive (HDD).

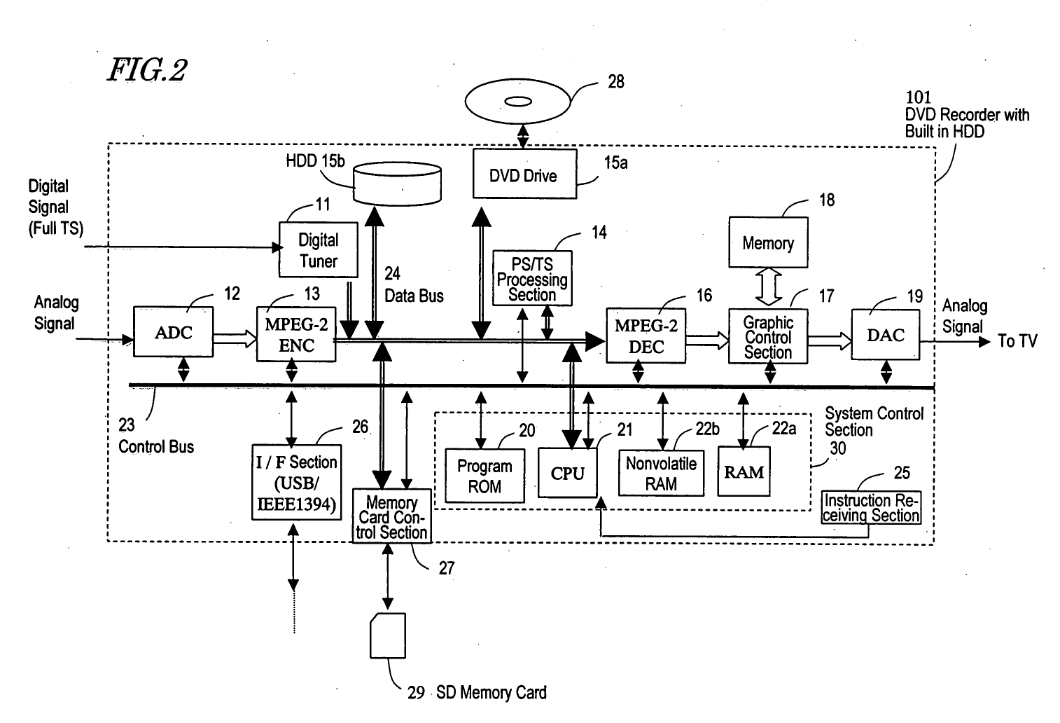

FIG. 2 shows a hardware configuration for a DVD recorder 101 with a built-in HDD, which will be simply referred to herein as a “recorder 101”. Hereinafter, the components of the recorder 101 will be described.

The recorder 101 includes a digital tuner 11, an analog-to-digital converter (ADC) 12, an MPEG-2 encoder (MPEG-2 ENC) 13, a PS/TS processing section 14, a DVD drive 15a, an HDD 15b, an MPEG-2 decoder (MPEG-2 DEC) 16, a graphic control section 17, a processing memory 18 for the graphic control section 17, a digital-to-analog converter (DAC) 19, an instruction receiving section 25, an interface (I/F) section 26, a memory card control section 27 and a system control section 30. Data can be exchanged between these components by way of a control bus 23 and/or a data bus 24. The control bus 23 is used to transmit a control signal and the data bus 24 is used to transmit data.

A DVD 28 and an SD memory card 29 are shown in FIG. 2 just for the sake of convenience of description. The DVD 28 and SD memory card 29 are not integral components of the recorder 101 but are storage media that are removable from the recorder 101.

Hereinafter, the functions of these components will be described one by one. The digital tuner 11 demodulates a broadcast signal, including a digital signal, thereby getting an MPEG-2 transport stream (TS). Then, the digital tuner 11 makes a partial TS, including data about a particular program, from the TS and then outputs it.

The ADC 12 converts an external analog signal into a digital signal. The MPEG-2 encoder 13 encodes the digital signal into an MPEG2-TS. The PS/TS processing section 14 converts the MPEG2-TS into an MPEG2-PS, or vice versa.

The DVD drive 15a reads and writes data from/on the DVD 28. This data may be content's data, for example. The HDD 15b reads and writes data from/on a hard disk and can also erase data from the hard disk. The HDD 15b may include an IDE (integrated drive electronics) interface, for example.

The MPEG-2 decoder 16 decodes an MPEG-2 signal to generate a baseband signal. The graphic control section 17 converts a resolution or an aspect ratio or superposes a still picture, generated by the device, on the baseband signal, for example. The processing memory 18 is used to temporarily store the data related to the processing done by the graphic control section 17. The DAC 19 converts the digital signal supplied from the graphic control section 17 into an analog signal.

The system control section 30 controls the overall operation of the recorder 101 and includes a program ROM 20, a CPU 21, a RAM 22a and a nonvolatile RAM 22b.

The program ROM 20 stores at least one computer program that has been defined to operate the recorder 101. The CPU 21 is a central processing chip functioning as a computer, reads the computer program stored on the program ROM 20, and extends and executes the program on the RAM 22a. As a result, the CPU 21 carries out various types of processing, including control processing, encryption processing, and decoding processing, in accordance with the program. The nonvolatile RAM 22b can retain the stored data even after the recorder 101 has been switched off and stores the data that has been generated by the CPU, for example.

The command receiving section 25 receives a user's command. The I/F section 26 is an interface that communicates with an external device and complies with the USB or IEEE 1394 standard, for example. The memory card control section 27 controls the transmission or reception of data to/from the memory card.

Hereinafter, the operation of the recorder 101 will be outlined.

Firstly, the recorder 101 operates as follows in bound recording a digital broadcast program (content) on the HDD 15b. The recorder 101 gets a broadcast signal, including a digital signal, demodulated by the digital tuner 11 and outputs a partial TS to the data bus 24. The partial TS is processed (e.g., encrypted) by the CPU 21, transmitted to the HDD 15b by way of the data bus 24 and then bound-recorded there.

Secondly, the recorder 101 operates as follows in moving the content that is bound-recorded on the HDD 15b to the DVD 28. Specifically, the recorder 101 transmits the content's data that is bound-recorded on the HDD 15b (i.e., encrypted partial TS) to the CPU 21 by way of the data bus 24. In response, the CPU 21 decodes the encrypted partial TS. The PS/TS processing section 14 converts the decoded partial TS data into an MPEG2-PS and then sends it back to the CPU 21. In response, the CPU 21 subjects the MPEG2-PS to encryption processing that should be done to record it on the DVD. Thereafter, the DVD drive 15a writes the encrypted MPEG2-PS on the DVD 28. When the MPEG2-PS has been written on the DVD 28, the CPU 21 instructs the HDD 15b to delete the partial TS data of that content.

Thirdly, the recorder 101 operates as follows in backing up a content that is bound-recorded on the HDD 15b onto the DVD 28. Specifically, the recorder 101 transmits the data that is bound-recorded on the HDD 15b (i.e., encrypted partial TS) to the DVD drive 15a by way of the data bus 24. In response, the DVD drive 15a records the received data on the DVD 28 as it is. The data that has been backed up on the DVD 28 may be restored onto the HDD 15b again in reverse order.

It should be noted that video/audio data should be recorded on a DVD in the program stream format. In the backup operation, however, an encrypted partial TS is written as mere data and does not have to be converted into the program stream format.

Fourthly, the recorder 101 operates as follows in playing back the content that is recorded on the DVD 15a. Specifically, the recorder 101 transmits MPEG2-PS data to the MPEG2-DEC 16 by way of the DVD drive 15a and data bus 24 and gets the data decoded into a baseband signal (digital signal) by the MPEG2-DEC 16. In this case, the encrypted data is also decoded by the MPEG2-DEC 16. Then, the graphic control section 17 converts the resolution and aspect ratio and superposes a still picture, generated by the device, on the baseband signal if necessary. Thereafter, the DSC 19 converts the digital signal into an analog signal and outputs the signal.

The recorder 101 may also play back the content that is recorded on the HDD 15b. In that case, the recorder 101 operates in substantially the same way as in playing back the content recorded on the DVD 15a. The differences are that the content's data is bound-recorded on the HDD 15b and that the MPEG2-DEC 16 decodes the encrypted partial TS.

The configuration and operation of the recorder 101 are just as outlined above. Hereinafter, preferred embodiments that use this recorder 101 will be described.

### EMBODIMENT 1

### 1-1. Functions of Recorder 101

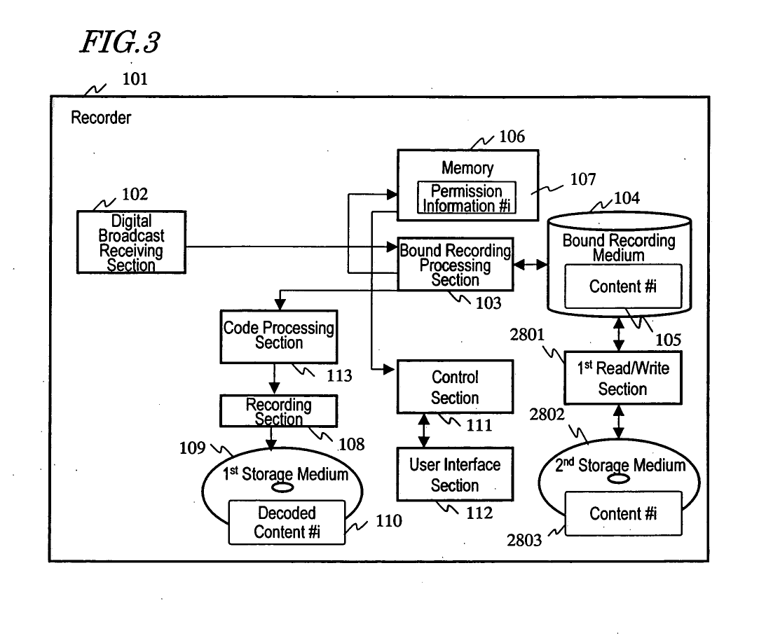

FIG. 3 shows an arrangement of functional blocks in the recorder 101 of this preferred embodiment. The recorder 101 includes a digital broadcast receiving section 102, a bound recording processing section 103, a bound recording medium 104, a memory 106, a recording section 108, a control section 111, a user interface section 112, an code processing section 113 and a first read/write section 2801.

Hereinafter, the functions of these components will be outlined one by one. The digital broadcast receiving section 102 receives a digital broadcast and outputs an MPEG-2 partial TS as a content.

The bound recording processing section 103 bound-records a content on the bound recording medium 104 and reads and erases the content that has been bound-recorded on the bound recording medium 104. The memory 106 stores the permission information 107 on a content-by-content basis.

The code processing section 113 encrypts the content supplied from the bound recording processing section 103 to record the content on the storage medium 109. The recording section 108 records the encrypted content 105 as a content 110 on a first storage medium 109. The first read/write section 2801 records the content 105 that has been bound-recorded on the bound recording medium 104 on a second storage medium 2802 and plays it back.

The correspondence between the components shown in FIG. 3 and those shown in FIG. 2 will be described. The digital broadcast receiving section 102 corresponds to the digital tuner 111 shown in FIG. 2. The bound recording processing section 103, code processing section 113 and control section 111 correspond to the CPU 21, which means that the CPU 21 operates as the bound recording processing section 103, code processing section 113 and control section 111. Also, the bound recording medium 104 corresponds to the HDD 15b and the memory 106 corresponds to the nonvolatile RAM 22b.

The recording section 108 and the first read/write section 2802 correspond to the DVD drive 15a. The first and second storage media 109 and 2802 are DVDs 28. The user interface section 112 corresponds to, and is implemented by, the command receiving section 25 and the graphic control section 17.

### 1-2. Operation of the Recorder 101 in Outline

The digital broadcast receiving section 102 receives a digital broadcast, demodulates it, and if it has been encrypted, decoded it. As a result of the decoding, an MPEG-2 transport stream (TS) is got.

A number of programs may have been multiplexed together in the MPEG2-TS. The MPEG2-TS includes not only video and audio elementary streams but also information tables that are collectively referred to as “program specific information (PSI)” and “service information (SI)”. The digital broadcast receiving section 102 rearranges this TS into an MPEG-2 partial TS, including information about only a single program, and outputs it.

The digital broadcast receiving section 102 also examines copyright-protection-related information among various pieces of PSI/SI information to detect a state such as “copying prohibited (or copy never)”, “copying permitted only one generation (or copy one generation)” or “copying permitted without restrictions”. The bound recording processing section 103 updates the “copy one generation” content into the “copy never” state and then bound-records it on the bound recording medium 104 and reads or erases it from the medium by a method that deters illegal access. Such an illegal access deterring method will be described in detail later.

Only within 90 minutes after its reception, the “copy never” content may be bound-recorded on the bound recording medium 104 by the illegal access deterring method. Once 90 minutes have passed, however, the content must be erased. Meanwhile, the “copying permitted without restrictions” content may be bound-recorded on the bound recording medium 104 freely.

The memory 106 retains the content's permission information 107 by a non-alterable method. The recording section 108 records the content 105 that has been bound-recorded on the bound recording medium 104 on the first storage medium 109.

The first read/write section 2801 records the content that has been bound-recorded on the bound recording medium 104 on the second storage medium 2802 by a non-alterable method. Also, the first read/write section 2801 plays back the content that was recorded on the second storage medium 2802 and bound-records it on the bound recording medium 104 again.

In accordance with the user's manipulations through the user interface section 112, the control section 111 controls the memory 106, the recording section 108, the first read/write section 2801 and so on.

Specifically, on receiving a request to bound-record a content on which the “copy one generation” restriction is imposed, the control section 111 makes the bound recording processing section 103 update the content into the “copy never” state and bound-record it on the bound recording medium 104 and gets the content's permission information 107, showing that the content is accessible, stored in the memory 106.

On the other hand, in response to a request to move a content on which the “copy never” restriction is imposed, the control section 111 makes the bound recording processing section 103 read the content 105 that has been bound-recorded on the bound recording medium 104, gets the content recorded on the first storage medium 109 by the recording section 108, and changes that content's permission information 107 stored in the memory 106 into “inaccessible” only when that content's permission information 107 shows that the content is accessible. Furthermore, the content that has been bound-recorded on the bound recording medium 104 may be erased.

In response to a request to erase a content, the control section 111 carries out a control operation so as not to change the content's permission information 107 stored in the memory 106 but to erase the content 105 that has been bound-recorded on the bound recording medium 104.

If the recorder 101 further includes an output section (not shown) or is connected to a display device (not shown) to present a content thereon, then the control section 111 may also accept a request to play back the content. When such a content playback request is received, the control section 111 operates only if the permission information 107 of the “copy never” content shows that the content is accessible. More specifically, the control section 111 makes the bound recording processing section 103 read the content 105 that has been bound-recorded on the bound recording medium 104 and gets the content presented on the display device or output from the output section. In that case, the permission information 107 of the content stored in the memory 106 is not changed.

Examples of preferred output sections include an analog (e.g., NTSC composite or component) output terminal compliant with the CGMS-A and Macrovision, an HDMI (High-Definition Multimedia Interface) terminal compliant with the HDCP (High-Bandwidth Digital Content Protection), an IEEE 1394 terminal compliant with the DTCP (Digital Transmission Content Protection), a 10 BASE-T terminal, a 100 BASE-TX terminal, and a 1000 BASE-T terminal. The display device may be a CRT, a liquid crystal display device or a plasma display device, for example.

When a “copy never” content is output, the copy control information is set to “copy never” or “copying prohibited” according to the CGMS-A or the DTCP. A Macrovision signal is added to an analog signal according to the APS (Analog Protection System) bit of that content. In this manner, the output content is protected.

Furthermore, in response to a request to back up a content, the control section 111 gets the content that has been bound-recorded on the bound recording medium 104 recorded by the first read/write section 2801 on the second storage medium 2802. In that case, the permission information 107 of that content stored in the memory 106 is not changed.

Also, when a request to restore a content is received, the control section 111 gets the content that has been recorded on the second storage medium 2802 read by the read/write section 2801 and bound-recorded on the bound recording medium 104 again only if the permission information 107 of that content stored in the memory 106 shows that the content is accessible. In that case, the permission information 107 of that content stored in the memory 106 is not changed, either.

### 1-3. Details of Respective Components of Recorder 101

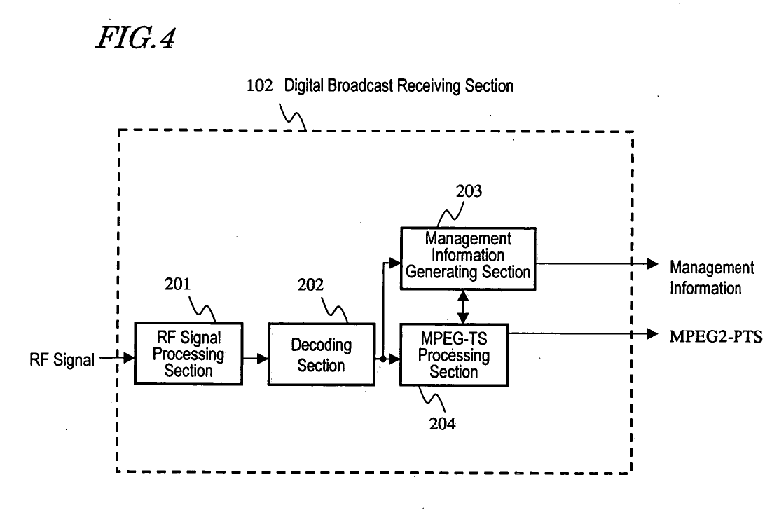

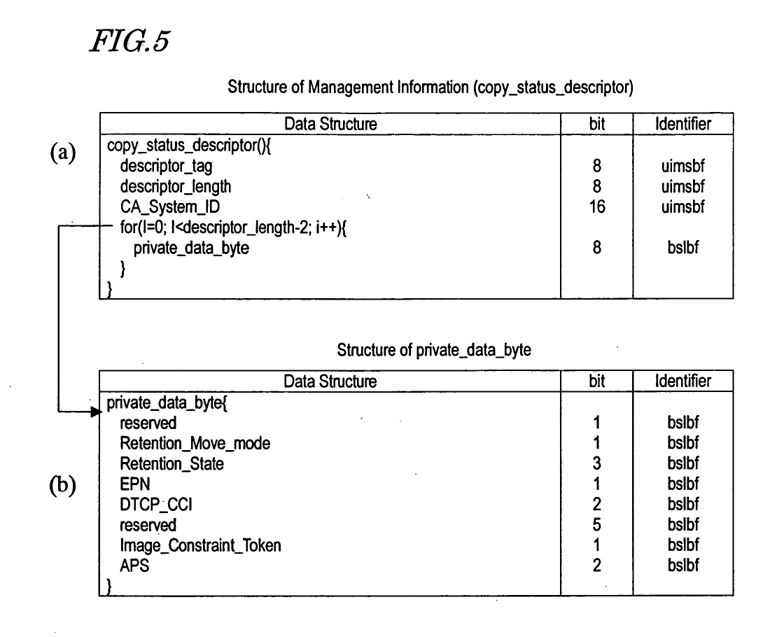

FIG. 4 shows an arrangement of functional blocks in the digital broadcast receiving section 102. The digital broadcast receiving section 102 includes an RF signal processing section 201, a decoding section 202, a management information generating section 203, and an MPEG-TS processing section 204.

The RF signal processing section 201 demodulates an RF signal representing the received digital broadcast and outputs an MPEG2-TS. The decoding section 202 decodes the encrypted MPEG2-TS that has been supplied from the RF signal processing section 201.

The management information generating section 203 generates management information from the MPEG2-TS. More specifically, a management information table called a “program map table PMT” is included in the MPEG-TS. The management information generating section 203 generates management information about copyright-related information in this management information table.

The MPEG-TS processing section 204 extracts only the data about a designated program from an MPEG2-TS, in which multiple programs are multiplexed together, thereby generating an MPEG-2 partial TS (partial transport stream).

Hereinafter, the management information (copy status descriptor) generated by the management information generating section 203 will be described in detail.

FIG. 5(a) shows an exemplary data structure of the management information (copy status descriptor). This management information is also called “copyright protection information”. FIG. 5(b) shows the details of the private_data_byte field in the management information.

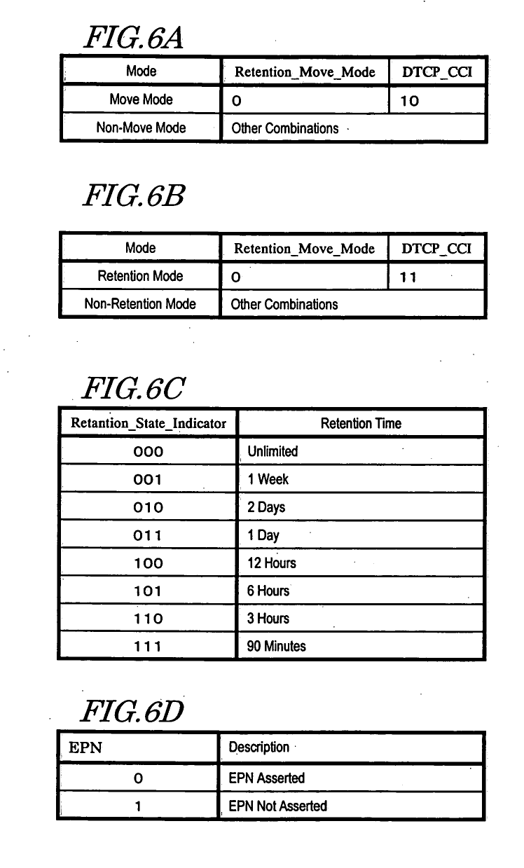

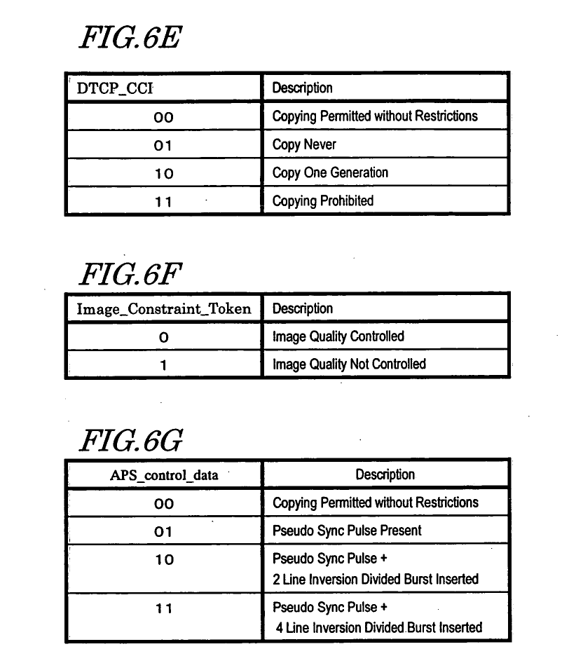

FIGS. 6A through 6G show values that can be set in the respective fields of the private_data_byte field and their meanings. The values are determined based on the settings of the digital copy control descriptor and content availability descriptor included in the PMT.

The copy status descriptor, generated as the management information, is sent to the MPEG-TS processing section 204 and inserted into the first one of the two types of loop structures provided for the PMT.

This management information may be bound-recorded in a unique format in the management information files of the bound recording medium 104. This is because the management information will be needed to bound-record a content or control the content by copying or moving it onto a removable storage medium as will be described later. It should be noted that if the copyright protection information has been altered, then the content could be used illegally. To deter such illegal use, various measures, including encryption, addition of a check code to detect the alteration, and recording the content in an area that is not accessible for users, are taken.

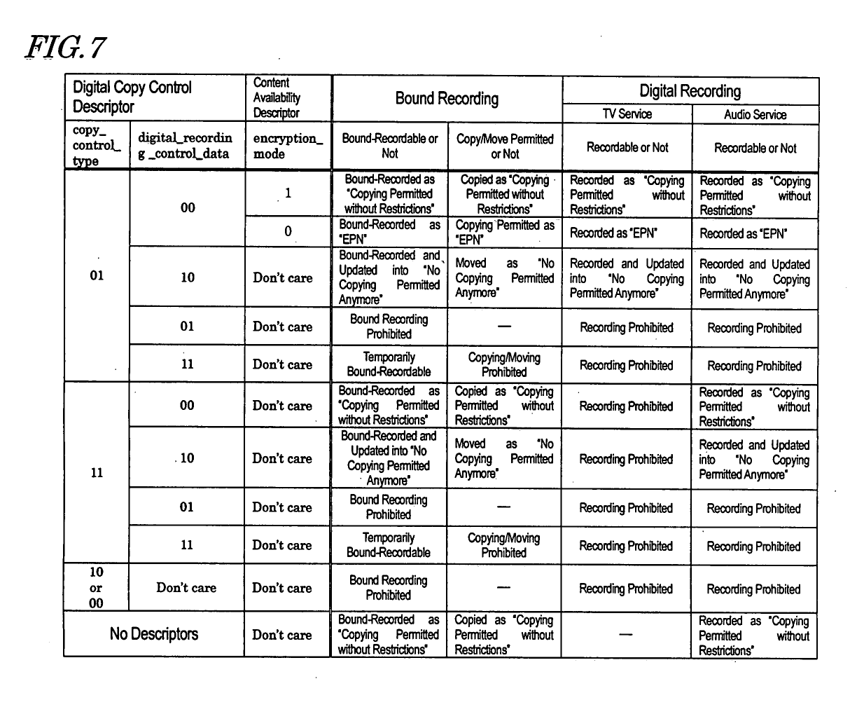

It is in accordance with the copyright information of a given content whether or not the content may be bound-recorded and how the content should be bound-recorded. FIG. 7 shows how the copyright protection information defines the bound recording operation and the operation of digitally recording or moving a content onto a removable storage medium.

If the digital_recording_control_data of the digital copy control descriptor is “10” indicating “copying permitted only one generation (copy one generation)”, the copy control information on the bound recording medium is bound-recorded as “no copying permitted anymore (copy never)”. In that case, the content is bound-recorded by a method that makes illegal access impossible. The content that is bound-recorded as “copy never” may not be copied to a storage medium but can be moved thereto.

Move can be made only to a single built-in or digitally connected storage medium. No content with a duration exceeding one minute should be playable at both the source of the content on the move and the destination thereof at the same time during the move processing. Furthermore, after the move has been made, the content should not be available at both the source and destination thereof at the same time. That is to say, when the move is completed, the content at the source is made non-playable. These methods of realization will be described more fully later.

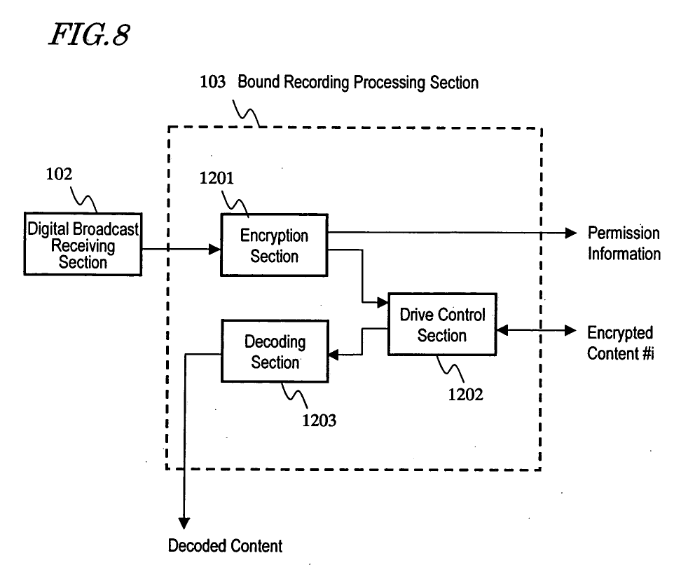

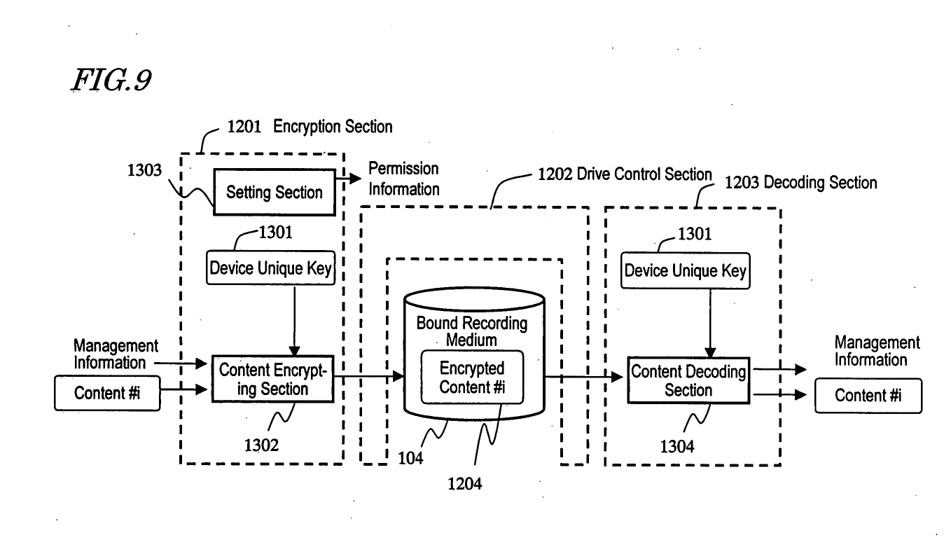

Next, the bound recording processing section 103 will be described with reference to FIG. 8, which shows an arrangement of functional blocks in the bound recording processing section 103. The bound recording processing section 103 includes an encryption section 1201, a drive control section 1202 and a decoding section 1203. The functions of the encryption section 1201, drive control section 1202 and decoding section 1203 are realized by the CPU 21 shown in FIG. 2.

The encryption section 1201 encrypts a “copy one generation” content by a method that requires at least device's own or content's own decoding information. At the same time, the encryption section 1201 also generates the permission information to be described later. The drive control section 1202 bound-records a content that has been encrypted (which will be referred to herein as an “encrypted content”) on the bound recording medium 104. Also, the control section 1202 reads or erases the encrypted content that has been bound-recorded on the bound recording medium 104. The decoding section 1203 decodes the encrypted content.

FIG. 9 shows more detailed configurations for the encryption section 1201 and the decoding section 1203. These configurations are adopted to encrypt and decode a content by a method that requires unique decoding information for each individual device.

The encryption section 1201 includes a content encryption section 1302 and a setting section 1303 for setting the permission information and holds a device unique key 1301. Meanwhile, the decoding section 1203 includes a content decoding section 1304 and also holds the device unique key 1301. The device unique key 1301 does not have to be held by each of the encryption section 1201 and decoding section 1203 but these sections may be designed so as to share the same key in common.

The content encryption section 1302 encrypts a given content with management information and the device unique key 1301. The encryption method may be unique to the device, and therefore, any code may be used as long as a predetermined code intensity is achieved. As a code for an AV content, for example, a common key block code such as DES, MULTI2, MISTY, C2 or AES is often used.

The device unique key 1301 is embedded such that a value unique to the device is not known to any outsider. The key may be embedded by performing code-related processing inside a semiconductor such that the device unique key and other key-related intermediate data are never accessible from outside of the semiconductor. Then, the device unique key 1301 is encrypted into a unique code and stored in a nonvolatile storage device (such as a flash memory) outside of the encryption processing semiconductor. The device unique key that has been encrypted during the access is loaded into the encryption processing semiconductor and the unique code is decoded and used inside the encryption processing semiconductor.

The management information includes: copyright management information stored in the copy status descriptor mentioned above; content's identification information; and various sorts of content attribute information such as title, category, content's duration, recording date and time, source information (e.g., broadcaster's name as for a digital broadcast), brief program description, detailed program description, resolution, age-based viewing control, and associated URLs.

The management information may be either arranged as a header at the top of the given content or bound-recorded as a table separately from the content. Alternatively, part of the management information may be stored as a header and the rest as a table. If the copyright management information or the content's identification information were altered, however, illegal access could not be denied.

To block such illegal access, the management information that should not be altered may be arranged at a header portion of a given content and incorporated into block encryption by using a CBC (Cipher Block Chaining) mode. In that case, even though the header portion is still non-encrypted, the illegal access can be denied because if this portion were altered, then the code that follows that portion could not be decoded properly.

Alternatively, a file that stores only management information collectively separately from the content may be created and then encrypted. As another alternative, the hash value of the file contents may be calculated and stored along with the file. And when the file is opened, the hash value of the file content may be calculated again and compared to the originally stored one. Then, the altered part, if any, can be detected.

The setting section 1303 sets the permission information of the content. The permission information is generated for every content and stored in the memory 106. The details of the permission information will be described more fully later.

The encrypted content is bound-recorded on the bound recording medium 104 by the drive control section 1202. In this case, the recording format may be defined arbitrarily. That is why the bit stream of a partial TS representing the encrypted content can be recorded as it is, the image or sound quality is never debased, and associated data is never lost, either.

On the bound recording medium 104, also recorded is a management information file by the drive control section 1202. As described above, the bound recording medium 104 is supposed to be the HDD 15b (see FIG. 2). Alternatively, the bound recording medium 104 may also be any other storage medium, e.g., a flash memory that uses a PCMCIA (Personal Computer Memory Card International Association) interface.

The bound recording medium 104 is fixed in the recorder 101. But the user may remove the bound recording medium 104 by opening its housing. Also, by connecting the bound recording medium 104 to a personal computer, for example, he or she can back up the encrypted content on another medium. However, the copyright will not be infringed even by such a conduct. This is because only the encrypted content (and its management information file) is backed up and its code is decodable only by the decoding section 1203. That is why the encrypted content that has been backed up on another medium cannot be viewed as a content by any other device but the recorder 101.

The encrypted content 1204 that is bound-recorded on the bound recording medium 104 is read by the drive control section 1202 when necessary and then decoded by the content decoding section 1304 with the device unique key 1301. At the same time, the associated management information is also read if necessary. If a hash value has been added to deter the alteration of the management information, then the content is checked for alteration. And if any altered part has been detected, a predetermined measure is taken. For example, the access to the content may be denied. Alternatively, its playback may be permitted but its move may be prohibited.

The encrypted content 1204 that is bound-recorded may be erased by the drive control section 1202 if necessary. The content may be erased by deleting the allocation information of the encrypted content 1204 from the file allocation table (not shown) of the bound recording medium 104. To erase the content even more completely, the data of the encrypted content 1204 may be overwritten with another data.

A type of encryption/decoding processing that requires unique decoding information for each single device has been described with reference to FIG. 9. However, unique decoding information may also be defined on a content-by-content basis.

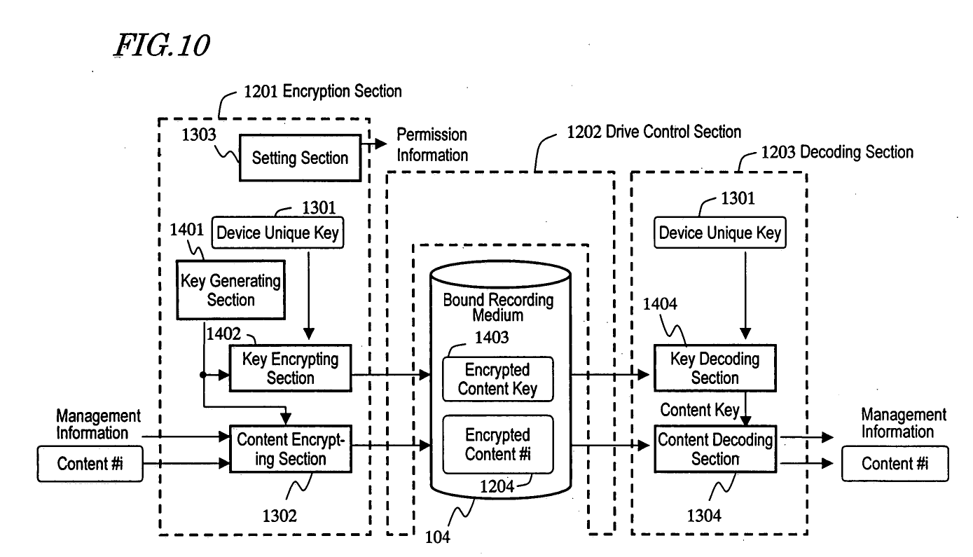

FIG. 10 shows a configuration for encrypting and decoding a content by a method that requires unique decoding information for each single content. The difference between the configurations shown in FIGS. 9 and 10 will be pointed out. The encryption section 1201 further includes a key generating section 1401 and a key encrypting section 1402. The decoding section 1203 further includes a key decoding section 1404.

When a request to bound-record a content is received, the key generating section 1401 generates a unique content key for each and every content. More specifically, a key with a predetermined bit length is generated by using a random number generating function.

The key encrypting section 1402 encrypts the content key with the device unique key 1301. The encryption method may be unique to the device, and therefore, any code may be used. For example, a common key code such as DES, MULTI2, MISTY, C2 or AES may be used.

The content encryption section 1302 encrypts the partial TS and the management information with the content key. On the bound recording medium 104, bound-recorded are the encrypted content and the encrypted content key by the drive control section 1202.

The encrypted content 1204 and the encrypted content key 1403 that are bound-recorded are read by the drive control section 1202 if necessary. First, the decoding section 1203 decodes the encrypted content key 1403 with the device unique key 1301, thereby getting the content key. Next, the decoding section 1203 decodes the encrypted content 1204 using this content key, thereby getting the original non-encrypted content. At the same time, the associated management information is also read and decoded if necessary.

The configuration and processing shown in FIG. 10 are more complicated than those shown in FIG. 9 but can speed up the processing effectively unless the encryption method is changed while the content is being copied or moved. This is because the encrypted content has only to be transferred as it is and does not have to be either decoded or encrypted again. Nevertheless, the content key needs to be decoded once and then re-encrypted with the device unique key at the destination of the copy processing.

Referring back to FIG. 3, the memory 106 retains the content's permission information by a method that deters illegal alteration.

The illegal alteration of the content's permission information may be deterred by integrating the memory 106, control section 111 and setting section 1303 shown in FIG. 10 together as a single semiconductor circuit, for example. This means that the CPU 21 and the nonvolatile RAM 22b, which are shown as separate components in FIG. 2, are combined together (by incorporating the nonvolatile RAM 22b into the CPU 21, for example). And the memory 106 of this circuit may be designed so as to be externally inaccessible physically but accessible from the setting section 1303 and control section 111 only by a predetermined method.

When a request to bound-record a content is received, the accessibility setting section 1303 gets the content's permission information 107, showing that the content is accessible, stored in the memory 106. In response to a content move request, the control section 111 changes the content's permission information 107, stored in the memory 106, into “inaccessible”. In the other cases, the control section 111 prohibits any change of the permission information 107.

The illegal access can also be denied even if the memory 106, control section 111 and setting section 1303 are not integrated together. For example, at least some of the terminals of any semiconductor circuit may be arranged at locations from which a signal cannot be extracted easily (e.g., on the lower surface of a semiconductor package such as a ball grid array package) and a line that connects those terminals of the semiconductor circuit together may be arranged inside the substrate. Alternatively, semiconductor terminals may be partially coated with a resin and a line that connects those semiconductor terminals together may be arranged inside the substrate. Then, every external access can be denied physically.

Also, if the setting section 1303, memory 106 and control section 111 are not combined into a single semiconductor circuit, then cross-authentication may be required when semiconductor components need to communicate with each other. And only when the authentication is done, encrypted data may be exchanged between the semiconductor components such that any illegal external access is denied.

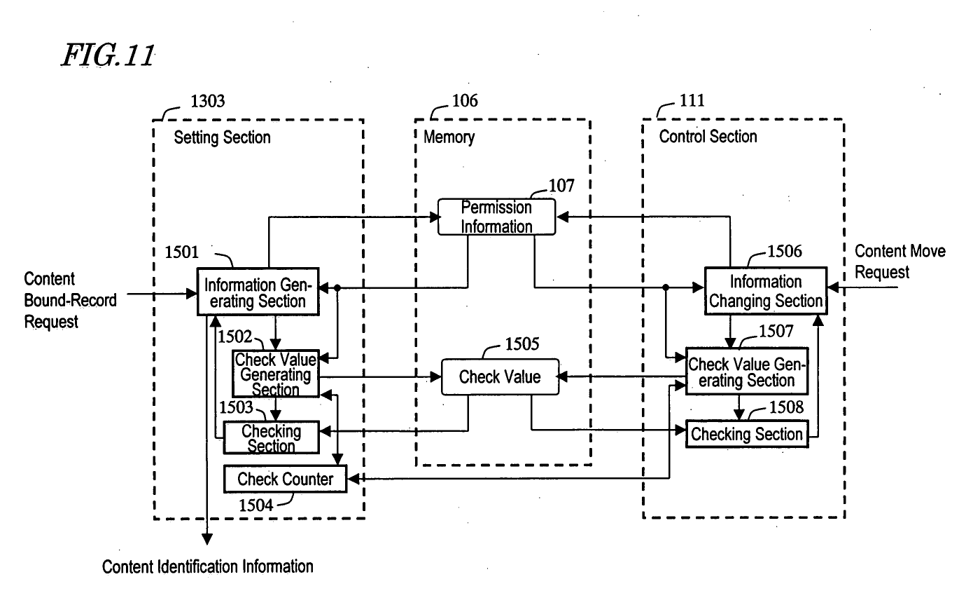

Optionally, a check value may also be used to deter the illegal alteration of the content's permission information. FIG. 11 shows a configuration that adopts a method of deterring alteration using a check value.

As used herein, the “check value” is a piece of information that is used to determine whether information to be checked has been altered or not. The check value may use a unidirectional function, for example. The “unidirectional function” is a function, on which a function f can be calculated easily but the inverse function if thereof is hard to calculate. In a unidirectional function G(d1, d2) that needs arguments d1 and d2, a combination of the permission information to be checked and a check counter value is used as d1, the device unique key is used as d2 and C=G(d1, d2) is used as a check value. Even if the permission information d2 and check value C can be accessed, it is still difficult to figure out the function G or the device unique key d2 based on them. If the permission information were altered into d2′, then a check value derived from the altered value would be C′=G(d1, d2′), which is different from the original check value C. That is why the alteration of the d2′ value can be detected.

The setting section 1303 includes an information generating section 1501 for generating the permission information, a check value generating section 1502, a checking section 1503 and a check counter 1504.

The check value generating section 1502 generates a check value 1505 by the method described above. The check value 1505 is stored in the memory 106 along with the permission information 107 to be described later.

The control section 111 includes an information changing section 1506, a check value generating section 1507 and a checking section 1508. The check value generating sections 1502 and 1507 may share the same processing in common. Likewise, the checking sections 1503 and 1508 may also share the same processing in common. The check counter 1504 is provided at an inaccessible location for the user (e.g., in a flash memory inside an LSI).

In this configuration, every time the check value generating section 1502 or 1507 generates a check value, the check counter 1504 can change its check count. Thus, even if both the permission information 107 and the check value 1505 are saved in advance in order to replace old values, such alteration can be deterred.

According to the method that uses a check value as shown in FIG. 11, only the count of the check counter 1504 needs to be saved at a non-user-accessible storage location and the permission information and the check value may be accessed by the user. It usually takes a lot of cost to secure such a non-user-accessible storage location and the storage capacity is limited for that purpose, too. That is why only the check count may be saved at such a non-user-accessible storage location and the memory 106 may be allocated to a part of bound recording medium 104. Then, a cost-effective allocation is realized.

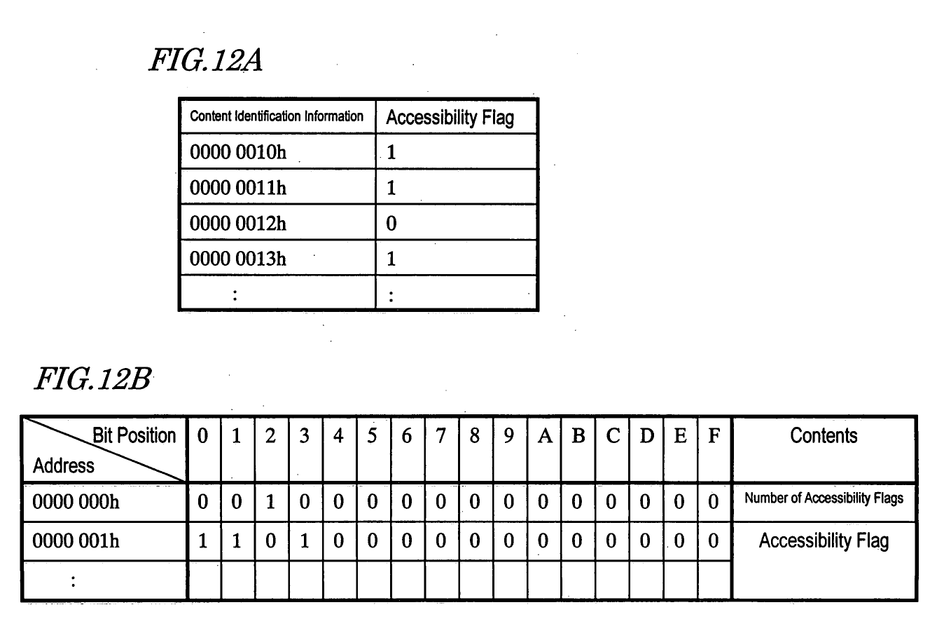

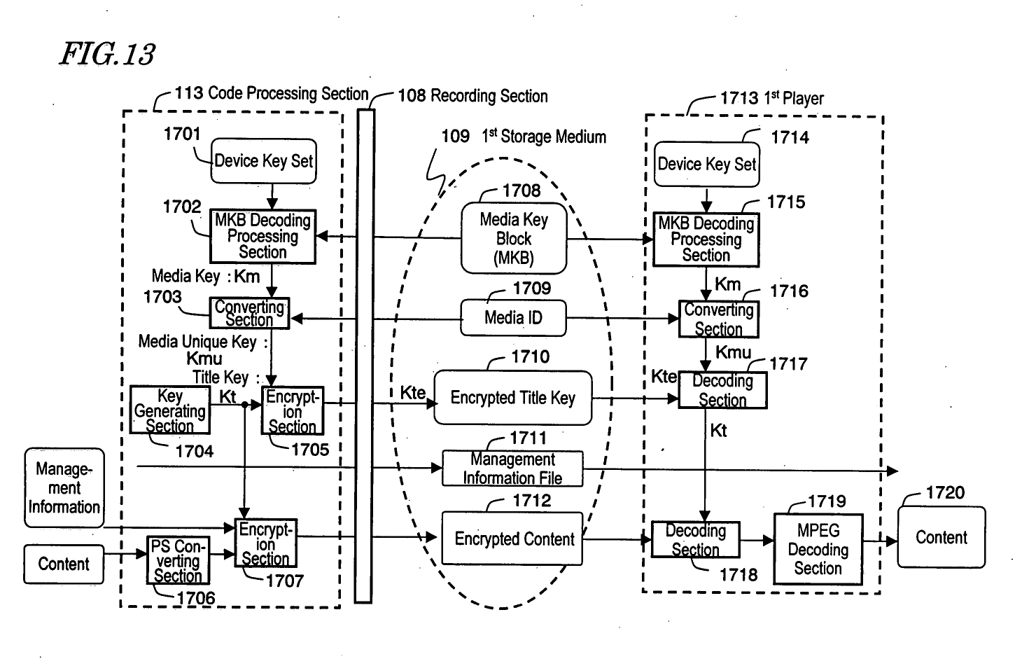

Next, the permission information will be described. FIG. 12A shows an exemplary piece of the permission information. Specifically, FIG. 12A shows whether four contents are accessible or not by using content identification information and accessibility flag in combination.

The content identification information is a piece of information for identifying a content by itself in the given device and may have a data width of N bits, for example. The value of the content identification information is gradually increased as contents are bound-recorded one after another.

The accessibility flag shows whether the given content is accessible or not. For example, a flag of “1” shows that the content is accessible while a flag of “zero” shows that the content is inaccessible. In addition, the number of current accessibility flags is also stored.

At the time of allocation, the address “0000000h” may be used as representing the number of accessibility flags and the addresses “0000001h” and so on are used as representing content identification information as a combination of address information and bit position information as shown in FIG. 12A. The accessibility flag is arranged at its associated bit position of the address. In other words, the address information is allocated to the high-order seven bits and the bit position information is allocated to the eighth bit, thereby making eight-bit content identification information. FIG. 12B shows that the number of accessibility flags is four and that four pieces of content identification information “0000001h” through “00000013h” are effective. Among these pieces of information, the content identification information “00000012h” shows that the content is inaccessible and the other three pieces of content identification information show that those contents are accessible. It should be noted that “h” attached to the end of each address shows that this is a hexadecimal number.

Next, the code processing section 113 will be described in detail.

FIG. 13 shows an arrangement of functional blocks in the code processing section 113, which may be implemented by the CPU 21. Alternatively, a dedicated encryption processing coprocessor may be used.

To describe the information to be recorded on the first storage medium 109, various other components are shown in FIG. 13, too. In the following description, the first storage medium 109 is supposed to be a DVD-RAM, a DVD-RW or a DVD-R and the content is supposed to be encrypted and recorded by the CPRM method.

Hereinafter, the configuration and operation of the code processing section 113 will be described.

The code processing section 113 includes a device key set 1701, an MKB decoding processing section 1702, a converting section 1703, a key generating section 1704, an encryption section 1705, a PS converting section 1706, and another encryption section 1707.

The device key set 1701 consists of sixteen device keys and is distributed by a CPRM licenser to manufacturers. The combination of keys is changed appropriately by the licenser so that not all of the sixteen device keys distributed to one device match the counterparts of another. As a licensing condition, the device key set should be embedded in a device so as not to leak.

The MKB decoding processing section 1702 generates a media key Km based on the device key set 1701 and the media key block (MKB) 1708 of a first storage medium 109. The converting section 1703 converts the media key Km with the media ID 1709, thereby generating a media unique key Kmu. The key generating section 1704 generates a title key Kt if necessary. The encryption section 1705 encrypts the title key Kt with the media unique key Kmu. The PS converting section 1706 converts the content of the partial TS into an MPEG-PS (program stream). And the encryption section 1707 encrypts the output of the PS converting section 1706 with the title key Kt. The title key and content data are encrypted through the processing of these components and recorded on the first storage medium 109. The PS converting section 1706 may be implemented based on the PS/TS processing section shown in FIG. 2.

On the first storage medium 109, stored are a media key block (MKB) 1708, a media ID 1709, an encrypted title key 1710, a management information file 1711 and an encrypted content 1712.

The MKB 1708 is data like a “cryptographic key ring” so to speak, which is generated by encrypting a media key Km with all of the device keys issued by a licenser. The MKB 1708 is stored on the first storage medium 109 by a non-alterable method when the first storage medium 109 is manufactured. The MKB is produced based on the data that has been figured out with a new media key Km every time a predetermined number of media (e.g., one million as for DVDs) are manufactured.

The media ID 1709 is data that is uniquely allocated to each storage medium and is stored on the first storage medium 109 by a non-alterable technique when the storage medium is manufactured.

The content that has been encrypted so as to be recorded on the first storage medium 109, the encrypted title key and the management information file are recorded on the first storage medium 109 by the recording section 108.

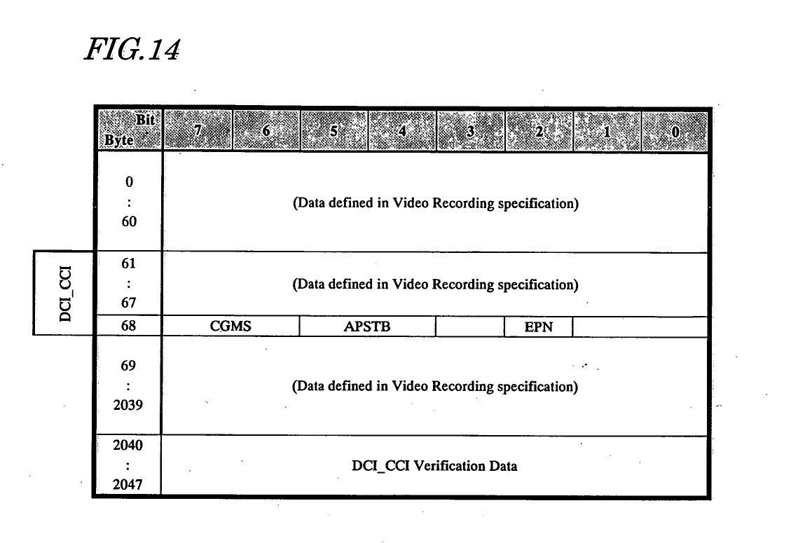

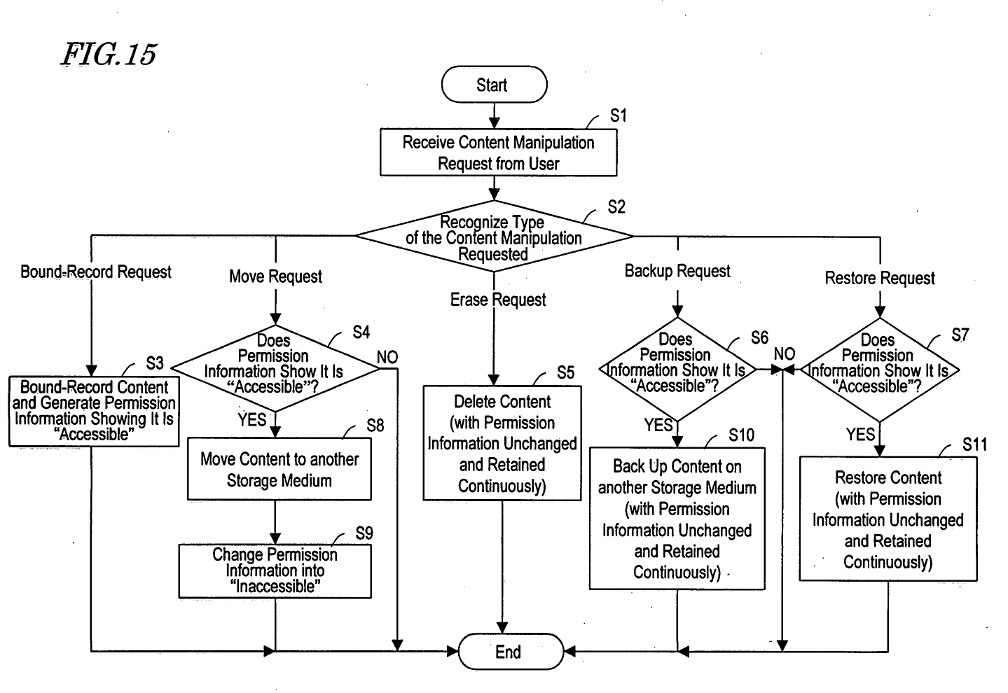

Part of the management information that has been read out by the drive control section 1202 of the bound recording processing section 103 is stored on the management information file 1711. FIG. 14 shows an exemplary data structure of the management information file 1711.

Since the content's data is recorded on a DVD, the management information file 1711 is recorded as a program stream defined by the Video Recording standard. This management information file 1711 is called a real-time data information (RDI) pack and has the same size of 2,048 bytes as an AV pack for a content. In the RDI pack, the copyright information is stored in CGMS, APSTB, and EPN fields. In the CGMS field, stored is digital_recording_control_data that has been included in the broadcast content.

Nevertheless, if the digital_recording_control_data is “copy one generation”, then the data is updated into “copy never” and then stored on the bound recording medium 104. Thus, “copy never” is also stored in the CGMS field of the RDI pack. APS_control_data and Encryption_mode (with inverted logic settings) are stored in the APSTB and EPN fields, respectively. The RDI pack is not encrypted but is protected by alteration preventive measures.

Next, it will be described with reference to FIG. 13 again how the data that has been recorded on the first storage medium 109 is played back. FIG. 13 shows a first player 1713 for convenience sake. However, the first player 1713 does not have to be provided separately from the recorder 101. A recorder normally has a playback function, too. Thus, the first player 1713 can be regarded as substantially included in the recorder 101.

The first player 1713 includes a device key set 1714, an MKB decoding processing section 1715, a converting section 1716, decoding sections 1717 and 1718, and an MPEG decoding section 1719.

The MKB decoding processing section 1715 generates a media key Km based on the device key set 1714 and media key block (MKB) 1708 of the first storage medium 109. Then, the converting section 1716 converts the media key Km with the media ID 1709, thereby generating a media unique key Kmu.

Next, the decoding section 1717 decodes the encrypted title key 1710 with the media unique key Kmu. The decoding section 1718 decodes the encrypted content 1712 with the title key Kt. And the MPEG decoding section 1719 decodes the decoded content (such as an MPEG2-PS). The content is output as a result of the processing done by these components.

If “copy never” in the CGMS field shown in FIG. 14 were altered into “copying permitted without restrictions”, then the player 1713 would regard the content as non-encrypted. Thus, the content that has actually been encrypted would be sent to the MPEG decoding section 1719 as it is and could not be decoded properly.

The APSTB field is used as a part of the cryptographic key by the encryption section 1707. Thus, the correct cryptographic key cannot be obtained from an altered value of the APSTB field during decoding, which should fail as a result. In the EPN field, check data is stored in the DCI_CCI_Verification_Data field, which can be used to spot alteration.

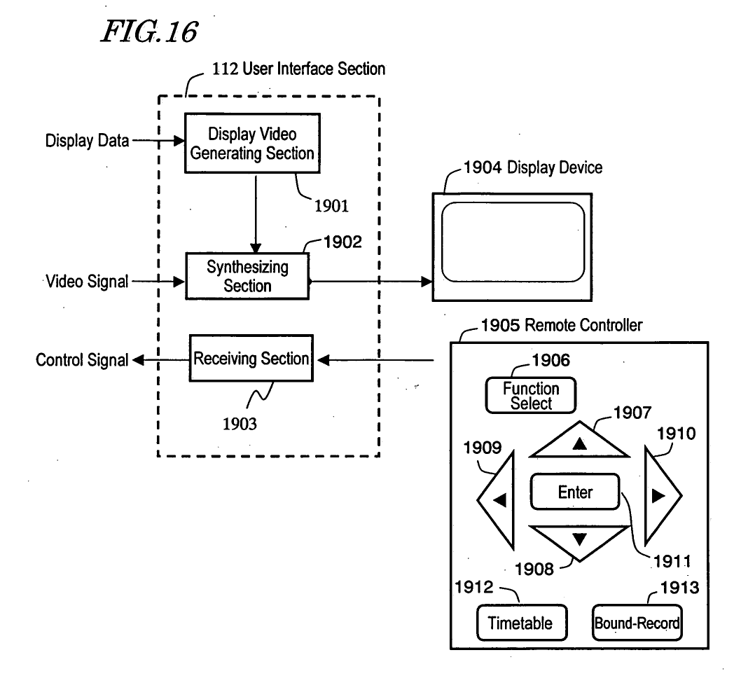

Finally, the function of the first read/write section 2801 will be described. The user interface section 112 will be described later with reference to FIG. 16.

The first read/write section 2801 records the content that has been bound-recorded on the bound recording medium 104 on the second storage medium 2802. In this preferred embodiment, the second storage medium 2802 is supposed to be a DVD-R, DVD-RW or a DVD-RAM.

If the content has been bound-recorded on the bound recording medium 104 so as to deny every illegal access, the content is encrypted with either the device unique key or the content key. Accordingly, if the first read/write section 2801 records the encrypted content on the bound recording medium 104 as it is (i.e., without being decoded) on the second storage medium 2802, then illegal access is impossible.

The format in which the first read/write section 2801 records the encrypted content on the second storage medium 2802 may be a unique one as long as the device can read and write the content. The recording performed by the first read/write section 2801 does not have to be compatible with a stream recording format (such as the DVD-Video format or the DVD Video Recording format). But the content just needs to be read or written as a data file. Accordingly, the bit stream of a partial TS representing an encrypted content can be recorded as it is, the image quality or sound quality is never debased, and the associated data is never lost. There is no need to convert an MPEG-2 partial TS into an MPEG2-PS, either.

If the content has been encrypted with a content key or if there is a management information file, not only the encrypted content but also the encrypted content key and management information file may be recorded on the second storage medium 2802.

To deny the illegal access even more effectively, the first read/write section 2801 may further encrypt the encrypted content by yet another method. Also, it is convenient to bound-record the management information file without encrypting it in order to know the content's information easily when it is bound-recorded on the bound recording medium 104. However, when the content is backed up on the second storage medium 2802, the management information file is preferably encrypted and recorded using the unique information of the recorder 101. This is because the management information file just needs to be used when restored in the recorder 101.

In this case, attention needs to be paid to various restrictions to be imposed when the content is recorded on the first storage medium 109. For most storage media, not only the physical standards of the storage media themselves but also application standards are defined. The latter is set to ensure recording and playback compatibility between devices. According to an application standard that is set mainly for the purpose of real-time recording and playback, however, restrictions are sometimes imposed on the image or sound quality according to the data transfer rate. For example, according to the DVD-Video and DVD Video Recording standards, the quality of recording should not exceed the standard resolution. According to another standard, an MPEG2-PS may be supported with compatibility with a package medium respected but an MPEG2-TS for use in broadcasting and other applications may not be recorded as it is. In this manner, a dubbing or move operation compliant with an application standard may be subject to various restrictions.

### 1-4. Procedure of Operating the Recorder 101

FIG. 15 shows a procedure of operating the recorder 101. The types of the operations shown in FIG. 15 are bound-recording, moving, erasing, backing up and restoring a content. The recorder 101 may also carry out other types of processing including playback and editing.

Hereinafter, the respective processing steps shown in FIG. 15 will be described. Those processing steps will be described in further detail later with reference to FIGS. 16 through 22.

First, in Step S1, the command receiving section 25 (see FIG. 2) receives a content manipulation request from the user. As used herein, the “content manipulation” means bound-recording, moving, erasing, backing up or restoring a content. Requests to make these manipulations will be referred to herein as a bound-record request, a move request, an erase request, a backup request and a restore request, respectively.

Next, in Step S2, the CPU 21 recognizes the type of the content manipulation requested. If it is a bound-record request, the process advances to Step S3. If it is a move request, the process advances to Step S4. If it is an erase request, the process advances to Step S5. If it is a backup request, the process advances to Step S6. And if it is a restore request, the process advances to Step S7.

In Step S3, the CPU 21 bound-records the content on the HDD 15b, generates permission information showing that the content is “accessible”, and then stores it on the nonvolatile RAM 22b to end the bound recording processing.

In Step S4, the CPU 21 determines whether or not the permission information shows that the content is “accessible”. If the answer is NO, the CPU 21 rejects the move request to end the processing. On the other hand, if the answer is YES, then the process advances to Step S8.

In Step S8, the CPU 21 moves the content, which is now bound-recorded on the HDD 21b, for example, to another storage medium. And when the move is complete, the CPU 21 changes the permission information, associated with that content in the recorder 101, into “inaccessible” in the next processing step S9.

In Step S5, the CPU 21 deletes the data of the content that has been bound-recorded on the HDD 15b, for example, thereby erasing the content from the recorder 101. In this case, the permission information is not changed but is retained as it is in the nonvolatile RAM 22b. After that, the processing ends.

In Step S6, the CPU 21 determines whether or not the permission information shows that the content is “accessible”. If the answer is NO, the CPU 21 refuses the backup request to end the processing. Since the content is no longer accessible, there is no need to accept the backup request.

On the other hand, if the answer is YES, then the process advances to Step S10. In Step S10, the CPU 21 backs up the content on another storage medium. In this case, the permission information is not changed but is retained as it is in the nonvolatile RAM 22b. After that, the processing ends.

In Step S7, the CPU 21 determines whether or not the permission information shows that the content is “accessible”. If the answer is NO, the CPU 21 refuses the restore request to end the processing. There may be a situation where no permission information associated with that content is present in the nonvolatile RAM 22b. This is true if the user attempts to restore a content that has been backed up by another device, not the recorder 101. In that case, the CPU naturally rejects the restore request and ends the processing.

On the other hand, if the answer is YES, then the process advances to Step S11. That means that the content has been backed up as a result of the processing steps S6 and S10.

In Step S1, the CPU 21 restores the content from another storage medium. In this case, the permission information on the nonvolatile RAM 22b is not changed. That is why the content's permission information during the backup operation applies as it is to that content.

### 1-5. Exactly how the Recorder 101 Operates in Response to User's Manipulations

Hereinafter, the respective processing steps shown in FIG. 15 will be described in further detail. First, a specific configuration that allows the user to make a content manipulation will be described.

FIG. 16 shows an arrangement of functional blocks in the user interface section 112. The user interface section 112 includes a display video generating section 1901, a synthesizing section 1902 and a receiving section 1903.

The display video generating section 1901, synthesizing section 1902 and receiving section 1903 respectively correspond to the CPU 21, graphic control section 17 and command receiving section 25 shown in FIG. 2.

The display video generating section 1901 either receives user display data from respective components of the recorder 101 or reads bound-recorded display data from the memory, thereby generating a GUI video (such as a menu screen). This GUI video is output as a GUI signal.

The synthesizing section 1902 superposes (or switches) the video signal, generated by getting the received or bound-recorded content played back by the recorder 101, on the video presented by the display video generating section 1901, thereby generating a video signal to be output out of the recorder 101. This video signal will be presented as video on the display device 1904. The display device 1904 is device for presenting the video signal supplied from the recorder 101 and may be a TV set or a liquid crystal projector, for example. When the display video generating section 1901 is not operating (e.g., when a content is being viewed and listened to), no GUI signal is generated. In that case, only the content's video signal is output.

The receiving section 1903 receives a user's request by way of a remote controller 1905, which is attached to the recorder 101, and outputs a control signal according to the request.

The remote controller 1905 has keys for controlling the recorder 101 and transmits a control signal as an infrared ray or a radio wave to the recorder 101 in response to the key manipulation. The remote controller 1905 includes at least a function select key 1906, an “up” arrow key 1907, a “down” arrow key 1908, a “left” arrow key 1909, a “right” arrow key 1910, an enter key 1911, a timetable key 1912 and a bound recording key 1913.

In the example illustrated in FIG. 16, the display device 1904 and remote controller 1905 are provided separately from the recorder 101. Alternatively, the display device 1904 and remote controller 1905 may be incorporated into the recorder 101. For example, the display device 1904 and remote controller 1905 may be replaced with a liquid crystal display device provided for the recorder 101 and buttons provided for the housing (not shown) of the recorder 101, respectively.

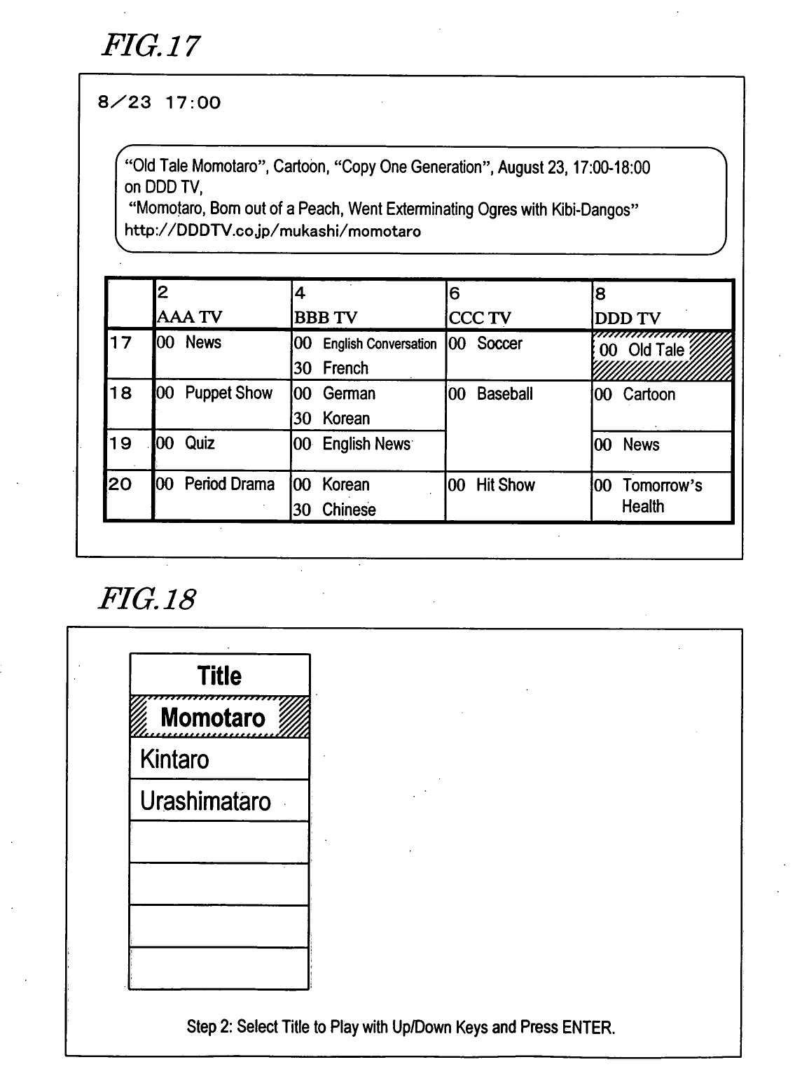

Hereinafter, a specific manipulating procedure to be followed by the user who requests to bound-record, move, erase, back up or restore a content will be described with reference to FIGS. 17 through 22. A content playback operation, associated with the content bound-recording operation, will be described, too.

### 1-5-1. Processing Responsive to Content Bound-Recording Manipulation

The manipulation of bound-recording a digital broadcast content may be carried out in the following procedure. First, the user pushes the timetable key 1912 of the remote controller 1905 shown in FIG. 16, thereby getting a timetable screen displayed. FIG. 17 shows an exemplary timetable screen. At the upper left corner of the screen, shown is the current date and time. On the upper right portion of the screen, shown are pieces of the management information of the program currently selected, including source information (i.e., broadcaster's name), scheduled recording (or on-air) date and time, category, copyright management information, title and brief description of the program. And under these pieces of information, presented is a timetable of programs on a broadcaster basis.

A program currently selected on the timetable is highlighted. In the example shown in FIG. 17, “Old Tale Momotaro”, which is scheduled to start at 17:00 on DDD TV, is now selected.

The user selects a program (or content) to be bound-recorded on the timetable screen by using the arrow keys. If he or she presses the bound-record key 1913 with some ongoing program selected, then a bound-record request is issued immediately. But if the program selected is scheduled to be on air in the future, then the bound-recording request is added to the recording schedule. In the latter case, when it is the time to start the scheduled bound recording, a bound-recording request is also issued.

When a content bound-record request is received, the processing step S3 shown in FIG. 15 is carried out. Specifically, the control section 111 makes the digital broadcast receiving section 102 generate the partial TS and management information of that content. For example, if the digital_recording_control_data field of the digital copy control descriptor of that content is “10” (copy one generation), then the content is encrypted by the encryption section 1201 and bound-recorded on the bound recording medium 104 as “copy never”.

The control section 111 also instructs the setting section 1303 to set permission information, showing that the content is accessible, in the memory 106. The setting section 1303 (see FIG. 11) sets the permission information in the following procedure.

First, as a preparation, the control section 111 checks the content for any illegal alterations that may have been done so far. The check value generating section 1502 reads the permission information of another content that is already retained in the memory 106, generates a check value based on this permission information 107 and the value stored in the check counter 1504, and sends it to the checking section 1503. In response, the checking section 1503 reads the current check value 1505 that is stored in the memory 106 and compares it to the check value that has been generated by the checking section 1503.

If these values do not agree with each other, it means that either the permission information 107 or the check value 1505 has been altered. Then, abnormality processing is carried out. The abnormality processing may be performed by notifying the user that this is abnormality processing and that all the contents that have been bound-recorded so far are inaccessible. The accessibility count information may also be reset to its initial value.

On the other hand, if the two values agree with each other, then it can be seen that the permission information 107 has never been altered. That is why the current permission information 107 may be used as it is. And the checking section 1503 notifies the information generating section 1501 of this check result.

The information generating section 1501 treats a value obtained by incrementing the current number of accessibility flags by one as the content identification information of the content to be newly bound-recorded. This number of accessibility flags is transmitted to the content encryption section 1302 (see FIG. 9) so as to be used as a piece of that content's management information. Then, the accessibility flag of the address associated with the new content identification information is set to “accessible”. This permission information is retained as new permission information 107 in the memory 106. The value of the check counter 1504 is also updated. Furthermore, the check value generating section 1502 generates a new check value based on the new permission information and the check counter value and gets it stored as a check value 1505 in the memory 106.

As a result of this processing, the content is bound-recorded and its permission information is generated.

### 1-5-2. Processing Responsive to Content Playback Manipulation

Once a content has been bound-recorded, the content may be played back. The playback may be carried out in the following procedure. First, the user presses the function select key 1906 of the remote controller 1905 shown in FIG. 16 to get a menu screen displayed. Then, he or she selects “playback” on the menu screen by using arrow keys and presses the enter key 1911 to get a playback screen displayed. FIG. 18 shows an exemplary screen displayed for the playback manipulation purpose. On this screen, a title list of playable contents is shown.

To show the list of playable titles, the identification information, title and copy protection status need to be known by reference to the management information of each content bound-recorded. First, the control section 111 checks the current permission information 107.

The check value generating section 1507 reads the content's permission information 107 that is already retained in the memory 106, generates a check value based on this permission information 107 and the value stored in the check counter 1504, and sends it to the checking section 1508. In response, the checking section 1508 reads the current check value 1505 that is stored in the memory 106 and compares it to the check value that has been generated by the checking section 1503.

If these values do not agree with each other, it means that either the permission information 107 or the check value 1505 has been altered. Then, abnormality processing is carried out. The abnormality processing may be performed by making all the contents that have been bound-recorded so far inaccessible.

On the other hand, if the two values agree with each other, then it can be seen that the permission information 107 has never been altered and is still valid. That is why the permission information 107 may be used as it is. The control section 111 generates the presentation data of the movable or playable content based on the management information and the valid permission information 107 and passes it to the user interface section 112.

As a result, if that content is present on the bound recording medium 104, the presence of the playable content is indicated. However, if the content is not present there, then its presence is not indicated. Furthermore, if that content is in “copy never” status, the permission information of that content is checked. And if the permission information shows that the content is “inaccessible”, the content is not shown as a playable content, either.

On the playback screen, the user selects his or her content to play back by using the arrow keys of the remote controller 1905. In the example shown in FIG. 18, “Momotaro” is highlighted, showing that this is the currently selected title. If he or she presses the enter key 1911 in such a state, the choice of “Momotaro” is determined. Then, “Momotaro” is read out from the bound recording medium 104 and then presented on a display device (not shown) and output from an output section (not shown, either). In the playback manipulation, the permission information is not changed.

### 1-5-3. Processing Responsive to Content Move Manipulation

Next, a move manipulation will be described. A move manipulation may be carried out in the following procedure. First, the user presses the function select key 1906 of the remote controller 1905 shown in FIG. 16 to get a menu screen displayed. Next, he or she selects “dubbing” on the menu screen by using arrow keys and presses the enter key 1911, thereby getting a dubbing screen displayed. “Move” is allocated to the dubbing screen as a dubbing (or copying) option.

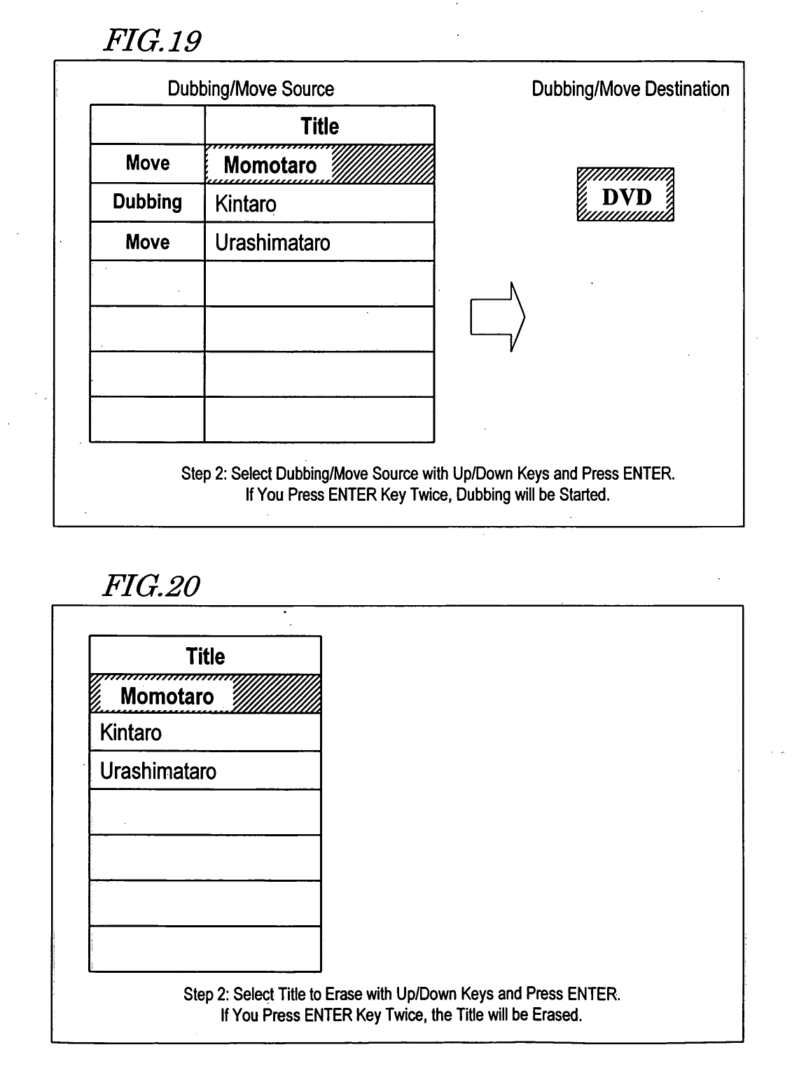

FIG. 19 shows an exemplary screen displayed for the move manipulation. On the left-hand side of the screen, shown is a title list of contents on the source of dubbing/moving operation. And on the left-hand side of each title, it is shown whether the title should be moved or dubbed.

When such a title list of contents on the move is shown, the identification information, title and copy protection status of each bound-recorded content need to be known by reference to the management information of the content. It is confirmed by the identification information whether or not the content is actually present on the bound recording medium 104. If that content is present on the bound recording medium 104, the presence of the content on the move is indicated. However, if the content is not present there, then its presence is not indicated. Furthermore, if that content is in “copy never” status, the permission information of that content is checked. And if the permission information shows that the content is “inaccessible”, the content is not shown as a content on the move, either. These processing steps are the same as the counterparts of the processing to be performed responsive to the content playback manipulation.

FIG. 19 shows that the two contents entitled “Momotaro” and “Urashimataro” have been selected as the objects of the move manipulation and that the content called “Kintaro” has been selected as the object of the dubbing manipulation.

If a content that has been bound-recorded in the “copy never” status has been selected as the object of the move manipulation, the content's permission information will be changed into “inaccessible” and the content on the bound recording medium 104 will be made no longer available once that content has been moved.

Meanwhile, if a content that has been bound-recorded in the “copying permitted without restrictions” status has been selected as the object of the dubbing manipulation, then that content will be still accessible even after the content has been dubbed.

On the dubbing screen, first, the user selects a content to be dubbed or moved by using the arrow keys of the remote controller 1905. In the example shown in FIG. 19, the content “Momotaro” is highlighted, showing that this is the currently selected title. If the enter key 1911 is pressed in this state, the choice of “Momotaro” is determined. If the user wants to choose another content in addition to the already picked one, then he or she needs to move the highlight to his or her desired content's title and determine his or her choice with the enter key 1911 pressed. When the content to dub or move is determined in this manner, the recorder 101 checks the remaining storage capacity of the destination of the dub or move processing. If the remaining storage capacity is less than the data size of the content, then the recorder 101 displays an alert message “DVD's storage capacity is insufficient; replace the DVD with another one or delete unnecessary title from the DVD”. As a result, the choice of the content is prohibited.

If the enter key 1911 is pressed twice back to back, then a confirmation message “move is about to start; press enter key again” is displayed on the bottom of the screen. And when the user presses the enter key 1911 once again, the start of moving the selected content “Momotaro” from the bound recording medium 104 to the storage medium 116 is instructed.

When a content move request is received, the processing steps S4, S8 and S9 shown in FIG. 15 are carried out. The processing step S4 is the step of determining whether or not the permission information shows that the content is accessible. Thus, the processing steps S8 and S9 will be described in further detail by way of specific examples.

Hereinafter, the operation of moving a partial TS representing a content from the bound recording medium 104 to the first storage medium 109 by way of the recording section 108 will be described.

The move operation is carried out in the following procedure including the steps of:
(1) cryptographic key preprocessing;
(2) recording the encrypted content 1712 on the first storage medium 109;
(3) changing the permission information (into “inaccessible”); and
(4) recording the access information for the encrypted content 1712 and the encrypted title key 1710 on the first storage medium 109 and making the content readily available.

First, the cryptographic key preprocessing will be described. The code processing section 113 reads the media key block (MKB) 1708 shown in FIG. 13 from the first storage medium 109. The MKB processing section 1702 generates a media key Km by decoding the MKB 1708 with a device key in the device key set 1701.

However, if any device key leaked and known to a third party, then it would be possible to make a device or software that can decode the encrypted content illegally by using that device key. Thus, to deter such illegal access, MKB data corresponding to the leaked device key is replaced with different data. Then, it is possible to prevent a third party from obtaining a correct media key Km from the leaked device key. That is to say, by using the MKB, the illegal device or software that uses the leaked device key can be invalidated.

The same media key Km is applicable to a lot of storage media. That is why the code processing section 113 reads the media ID 1709 from the first storage medium 109 and gets the media key converted by the converting section 1703 with the media ID 1709, thereby generating a media unique key Kmu that is uniquely given to each storage medium. The cryptographic key preprocessing is carried out in this manner.

The content's management information may be recorded on the first storage medium 109 by using the cryptographic key in the following manner.

The area of the first storage medium 109 in which the encrypted title key 1710 is recorded has a capacity corresponding to a single encrypted title key. The code processing section 113 reads the title key status flag (not shown) of the first storage medium 109, thereby checking whether or not the encrypted title key has been recorded on the first storage medium 109.

If the encrypted title key has not been recorded yet in the area for the encrypted title key 1710 on the first storage medium 109, the key generating section 1704 generates a new key by using its random number generating function. On the other hand, if the encrypted title key has already been recorded in the area for the encrypted title key 1710, the code processing section 113 reads the encrypted title key 1710 from the first storage medium 109 and gets the title key Kt retrieved by a decoding section (not shown but having the same configuration as the decoding section 1717 of the first storage medium read/write section 1713) with the media unique key Kmu.

The PS converting section 1706 converts an MPEG-2 partial TS representing the content into MPEG2-PS data. The converted MPEG2-PS data is encrypted by the encryption section 1707 with the title key Kt and then recorded in the area of the storage medium 116 in which the encrypted content 1712 has been recorded. A part of the management information is stored in the management information file 1711. FIG. 14 shows an example of the management information file 1711. The encrypted content 1712 and management information file 1711 are recorded as a result of these processing steps.

At this point in time, no access information for the encrypted content 1712 has been recorded yet on the first storage medium 109. That is why even if the first storage medium 109 is removed from the recorder 101, the encrypted content 1712 still cannot be accessed. Before the encrypted title key has been recorded in the area for the encrypted title key 1710, the key generating section 1704 gets the title key Kt encrypted by the encryption section 1705 with the media unique key Kmu. C2 code is used as the code.

Thereafter, the information changing section 1506 changes the content's permission information in the memory 106 into “inaccessible” and stores it back to the memory 106 again. Then, the check counter 1504 updates its count and sends it along with the new permission information to the check value generating section 1507, thereby generating a new check value. And the new check value is also stored in the memory 106. By performing these processing steps, the content that has been bound-recorded on the bound recording medium 104 becomes no longer accessible.

After the content's permission information has been changed into “inaccessible”, the recording section 108 records the access information for the encrypted content 1712, etc., on the first storage medium 109. For example, in the file system of the first storage medium 109, the address information of the previously recorded AV and RDI packs is written on a predetermined file allocation table (not shown) and a navigation information file (not shown) for recording the title information of the encrypted content 1712 is written. Furthermore, pointer information for locating the file allocation table is written on the navigation information file.

If the encrypted title key has not yet been recorded on the area for the encrypted title key 1710, then the encryption section 1705 records the encrypted title key Kte in the area for the encrypted title key 1710.

As a result, the content on the first storage medium 109 becomes accessible now and the move processing is complete. When it is confirmed that the access information and so on have been recorded, the encrypted content may be deleted from the bound recording medium 104.

By copying the encrypted content onto the first storage medium 109 to change the content's permission information into “inaccessible” and then recording the access information for the encrypted content 1712, etc. on the first storage medium 109 in this manner, it is possible to satisfy the rule that no content with a duration exceeding one minute should be playable at both the source of the content on the move and the destination thereof at the same time during the move processing.

If the content could not be copied onto the first storage medium 109 due some defect thereof, then the user would be notified of the abnormality processing and the processing responsive to the move request should be ended without changing the permission information, the check counter value and the check value.

It should be noted that after the content's permission information has been changed into “inaccessible” and before it is confirmed that the access information and so on have been recorded successfully, the processing might sometimes end abnormally due to the disconnection of power supply, for example. The abnormality processing is also carried out in such a situation. In that case, neither the content on the bound recording medium 105 nor the encrypted content 1712 on the first storage medium 109 is accessible. If such a state persisted, it would cause a significant loss to the user. To avoid causing such a loss, after the recorder 101 has been turned ON again, the bound recording processing section 103 changes the content's permission information into “accessible” again, thereby making the content on the bound recording medium 105 accessible.

Once the move processing is complete, the content can be played back from the first storage medium 109 by the first player 1713. In playing back the content, the title key Kt is decoded using the device key set 1714, MKB decoding processing section 1715, converting section 1716 and decoding section 1717 and the encrypted content 1712 is decoded by the decoding section 1718 using the title key Kt. The resultant data (i.e., MPEG2-PS stream) is decoded by the MPEG decoding section 1719 into a baseband signal to be a viewable/audible content 1720.

In the example described above, the destination storage medium of the dubbing or move processing is supposed to be a single DVD. However, if another storage medium such as an SD memory card is also usable, then a plurality of destination storage media of the dubbing or move processing may be shown on the dubbing screen. In that case, the user can pick one of the media as the destination of the dubbing or move processing.

### 1-5-4. Processing Responsive to Content Erase Manipulation

Next, an erase manipulation will be described. An erase manipulation may be carried out in the following procedure. First, the user gets a menu screen displayed by pressing the function select key 1906 of the remote controller 1905. Then, he or she selects “erase” on the menu screen by using the arrow keys and presses the enter key 1911, thereby getting an erase screen displayed.

FIG. 20 shows an exemplary screen displayed responsive to the erase manipulation. On the screen, shown is a title list of erasable contents.

To show the list of erasable titles, the identification information, title and copy protection status need to be known by reference to the management information of each content bound-recorded. By reference to the identification information, it is confirmed whether or not the content in question is actually present on the bound recording medium 104. If the answer is YES, that content is shown as an erasable content. But if the answer is NO, then the content is not shown. Furthermore, if the content is in “copy never” status, the permission information of that content is checked. And if it is inaccessible, that content is not shown as an erasable content, either.

On the erase screen, first, the user selects a content to be erased by using the arrow keys of the remote controller 1905. In the example shown in FIG. 20, the content “Momotaro” is highlighted, showing that this is the currently selected title. If the enter key 1911 is pressed in this state, the choice of “Momotaro” is determined. If the user wants to choose another content in addition to the already picked one, then he or she needs to move the highlight to his or her desired content's title and determine his or her choice with the enter key 1911 pressed. If the enter key 1911 is pressed twice back to back, then a confirmation message “erase is about to start; press enter key again” is displayed on the bottom of the screen. And when the user presses the enter key 1911 once again, “Momotaro” is erased from the bound recording medium 104. In the erase manipulation, the permission information is not changed.

### 1-5-5. Processing Responsive to Content Backup Manipulation

Next, a backup manipulation will be described. A backup manipulation may be carried out in the following procedure. First, the user gets a menu screen displayed by pressing the function select key 1906 of the remote controller 1905. Then, he or she selects “backup” on the menu screen by using the arrow keys and presses the enter key 1911, thereby getting a backup screen displayed.

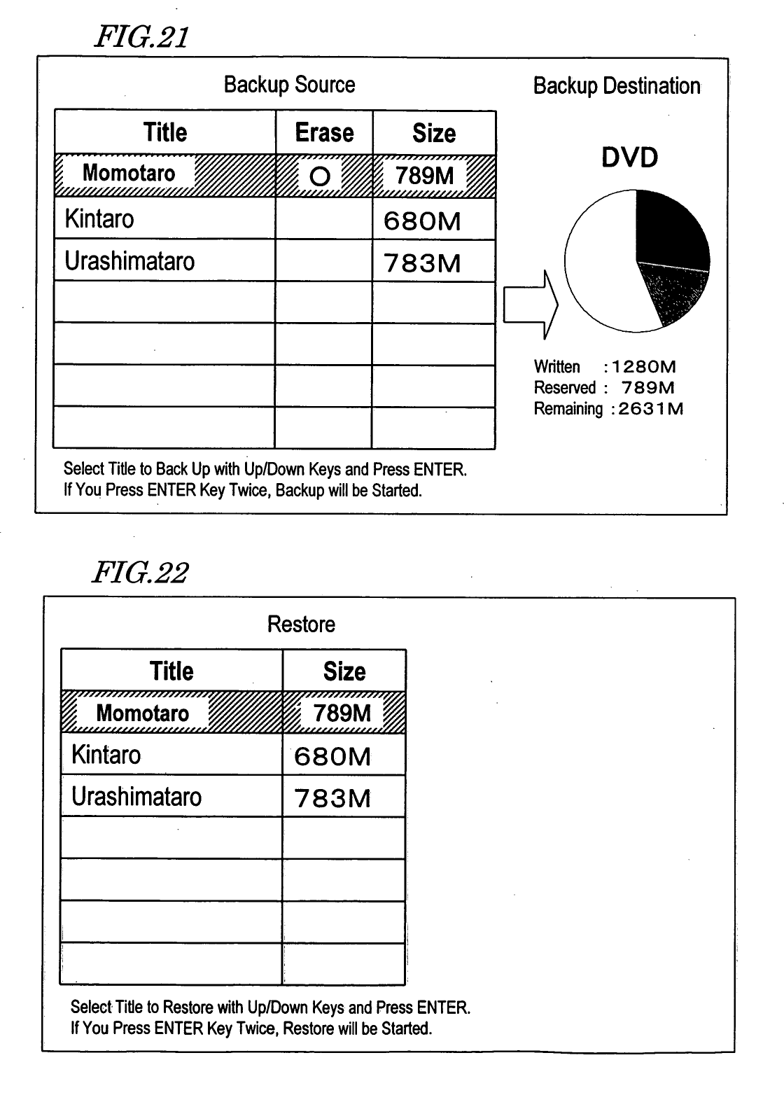

FIG. 21 shows an exemplary screen displayed responsive to the backup manipulation. On the left-hand side of the screen, shown are contents to be backed up. On the right-hand side of the title column, it is indicated whether or not the content will have to be erased from the bound recording medium 104 after having been backed up. And the size of the content is shown on the right.

To show the title list of the contents to be backed up, the identification information, title and copy protection status need to be known by reference to the management information of each content bound-recorded. By reference to the identification information, it is confirmed whether or not the content in question is actually present on the bound recording medium 104. If the answer is YES, that content is shown as a content to be backed up. But if the answer is NO, then the content is not shown. Furthermore, if the content is in the “copy never” status, the permission information of that content is checked. And if it is inaccessible, that content is not shown as a content to be backed up, either. On the right-hand side of the screen, shown is how much the second storage medium 2802 has been used as the destination of the backup operation. In the example shown in FIG. 21, data of 1,280 MB (megabytes) has already been written, a capacity of 789 MB has been reserved for the backup data this time, and the remaining capacity is 2,631 MB.

On the backup screen, first, the user selects the title of a content to be backed up by using the arrow keys of the remote controller 1905. In the example shown in FIG. 21, the content “Momotaro” is highlighted, showing that this is the currently selected title. If the enter key 1911 is pressed in this state, the choice of “Momotaro” is determined. This determination changes the reserved capacity on the second storage medium 2802, which is shown on the right-hand side as the destination of the backup operation. Thereafter, the user moves the highlight to the erase column by using the arrow keys and presses the enter key 1911 to check some content by an open circle on the erase column, which shows that the content will be erased from the bound recording medium 104 after having been backed up. If the user wants to choose another content in addition to the already picked one, then he or she needs to move the highlight to his or her desired content's title and determine his or her choice with the enter key 1911 pressed. When a content is selected, the recorder 101 sees if the second storage medium 2802 as the destination of the backup operation still has sufficient capacity available. If the remaining capacity is insufficient, an alert message is displayed to prevent the user from selecting that content.

If the enter key 1911 is pressed twice back to back, then a confirmation message “backup is about to start; press enter key again” is displayed on the bottom of the screen. And when the user presses the enter key 1911 once again, an instruction to back up “Momotaro” from the bound recording medium 104 onto the second storage medium 2802 is issued.

In response to the instruction to start backing up the content, the control section 111 makes the bound recording processing section 103 read the content 105 from the bound recording medium 104 and gets the encrypted content recorded on the second storage medium 2802 by the read/write section 2801 without decoding it. Also, the management information file of that content, if any, is also recorded on the second storage medium 2802. In this case, to show clearly which device has made the backup, a predetermined value is encrypted with the device unique information and recorded at a prescribed location on the management information file. The content's permission information 107, retained in the memory 106, is not changed. Furthermore, if the content has also been designated to be erased, the deletion of the content is carried out.

In the backup manipulation, the permission information is not changed. Accordingly, if the content that has been backed up by the user on the second storage medium 2802 is restored onto the bound recording medium 104, that content becomes accessible again for the recorder 101.

### 1-5-6. Processing Responsive to Content Restore Manipulation

Next, a restore manipulation will be described. A restore manipulation may be carried out in the following procedure. First, the user gets a menu screen displayed by pressing the function select key 1906 of the remote controller 1905. Then, he or she selects “restore” on the menu screen by using the arrow keys and presses the enter key 1911, thereby getting a restore screen displayed.

FIG. 22 shows an exemplary screen displayed responsive to the restore manipulation. On the screen, shown are contents to be restored. On the right-hand side of the title column, shown are the respective sizes of the contents.

To show the title list of the contents to be restored, the management information of each content, which has been backed up on the second storage medium 2802, is consulted to see if a predetermined value can be obtained by decoding information at a prescribed location with device unique information. If the predetermined value cannot be obtained, then it can be seen that the content backed up on the second storage medium 2802 was not backed up by this device. Thus, the user interface section 112 displays an alert message that the content was backed up by another device and aborts the restore operation. On the other hand, if the predetermined value has been obtained, then the content has been backed up by this device. Thus, the identification information, title and copy protection status need to be known. By reference to the identification information, it is confirmed whether or not the content in question is actually present on the second storage medium 2802. If the answer is YES, that content is shown as a content to be restored. But if the answer is NO, then the content is not shown. Furthermore, if the content is in the “copy never” status, the permission information of that content in the memory 106 is checked. And if it is inaccessible, that content is not shown as a content to be restored, either.

On the restore screen, first, the user selects the title of a content to be restored by using the arrow keys of the remote controller 1905. In the example shown in FIG. 21, the content “Momotaro” is highlighted, showing that this is the currently selected title. If the enter key 1911 is pressed in this state, the choice of “Momotaro” is determined. If the user wants to choose another content in addition to the already picked one, then he or she needs to move the highlight to his or her desired content's title and determine his or her choice with the enter key 1911 pressed. When a content is selected, the recorder 101 sees if the bound recording medium 104 as the destination of the restore operation still has sufficient capacity available. If the remaining capacity is insufficient, an alert message is displayed to prevent the user from selecting that content.

If the enter key 1911 is pressed twice back to back, then a confirmation message “restore is about to start; press enter key again” is displayed on the bottom of the screen. And when the user presses the enter key 1911 once again, an instruction to start restoring “Momotaro” from the second storage medium 2802 onto the bound recording medium 104 is issued.

In response to the instruction to start restoring the content, the control section 111 makes the read/write section 2801 read the encrypted content 2803 from the second storage medium 2802 without decoding it and gets the content bound-recorded on the bound recording medium 104 by the bound recording processing section 103. Also, the management information file of that content, if any, is also recorded on the bound recording medium 104. The content's permission information 107, retained in the memory 106, is not changed.

That is why if the content that was backed up by the user on another storage medium is restored onto the bound recording medium 104, then the content becomes accessible for the recorder 101 again.

It should be noted that by backing up the content on another storage medium by performing the backup processing described above, even if the bound recording medium 104 has been replaced with a new one due to failure, for example, that content can be restored without fail. This is because the permission information indispensable for the restore processing is retained on another storage medium (e.g., the nonvolatile RAM 22b) separately from the bound recording medium 104 so as not be altered illegally. A computer program for performing the backup processing is also stored on another storage medium (e.g., the program ROM 20) separately from the bound recording medium 104. Thus, the recorder 101 can perform the restore processing described above on the program, too.

In this preferred embodiment, when a content is either backed up or restored between the bound recording medium 104 and the second storage medium 2802, it is confirmed that the content's permission information is “accessible”. However, as this confirmation is made for the sake of user's convenience, the content may be backed up or restored without checking the content's permission information. In that case, if the permission information is “inaccessible” when a content that has been restored onto the bound recording medium 104 is going to be played back or moved, then the content is not accessible.

In the preferred embodiment described above, the first and second storage media 109 and 2802 are supposed to be DVD-Rs, DVD-RWs or DVD-RAMs. However, that is just an example. Neither of those storage media needs to have any special encryption recording scheme. But the storage medium just needs to record digital data. That is why any of various other storage media may be used as well.

Examples of preferred disks include recordable compact discs (such as CD-Rs and CD-RWs), mini discs (MDs), Hi-MDs, digital versatile disks (including DVD-RAMs, DVD-RWs, and DVD-Rs), +RW, +R, Blu-ray Discs (BDs), HD-DVDs and iVDR (Information Versatile Disc for Removable Usage). As semiconductor media, secure digital (SD) memory cards, memory sticks, and memory stick pro's may be used. Alternatively, D-VHS, dcc and other tapes may be used as well.

The present invention is naturally applicable to various other storage media to be developed from now on. In the preferred embodiment described above, only a single type of storage media are used. Alternatively, multiple types of storage media may be supported and a selected type of storage medium may be operated on as well.

In the preferred embodiment described above, the first and second storage media 109 and 2802 are provided separately. Alternatively, these storage media may be two different areas of the same storage medium. In that case, portions of the recording section 108 and the first read/write section 2801 for recording data on the storage medium may be shared in common. Optionally, the recording section 108 and the first read/write section 2801 may actually be the same section. At the time of move processing, the data may be recorded in a stream format so as to be playable by another player. During backup processing, on the other hand, the data may be recorded in such a recording format as to make the data available only when restored in the recorder 101.

According to the processing described above, while following the “copy one generation” content protection rule, a content that is dedicated to a given device without being restricted by the capacity of a bound recording medium can not only be bound-recorded but also be moved to a medium that is playable by another device. In addition, since the backup medium is supported, a backup/restore operation can be done easily.

In the preferred embodiment described above, when a content is moved onto the first storage medium, the content is encrypted as an example. However, when moved to the first storage medium, the content does not always have to be encrypted. For example, if the given content is a music content, a mini disc (MD) may be used as the first storage medium. On an MD, a content is compressed and recorded by the ATRAC method but is not encrypted.

### EMBODIMENT 2

### 2-1. Functions of Recorder 101

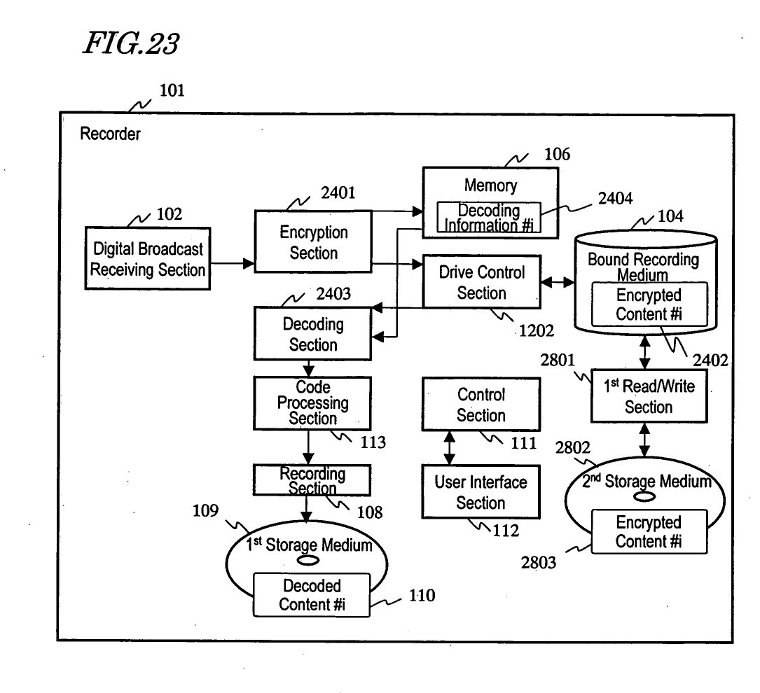

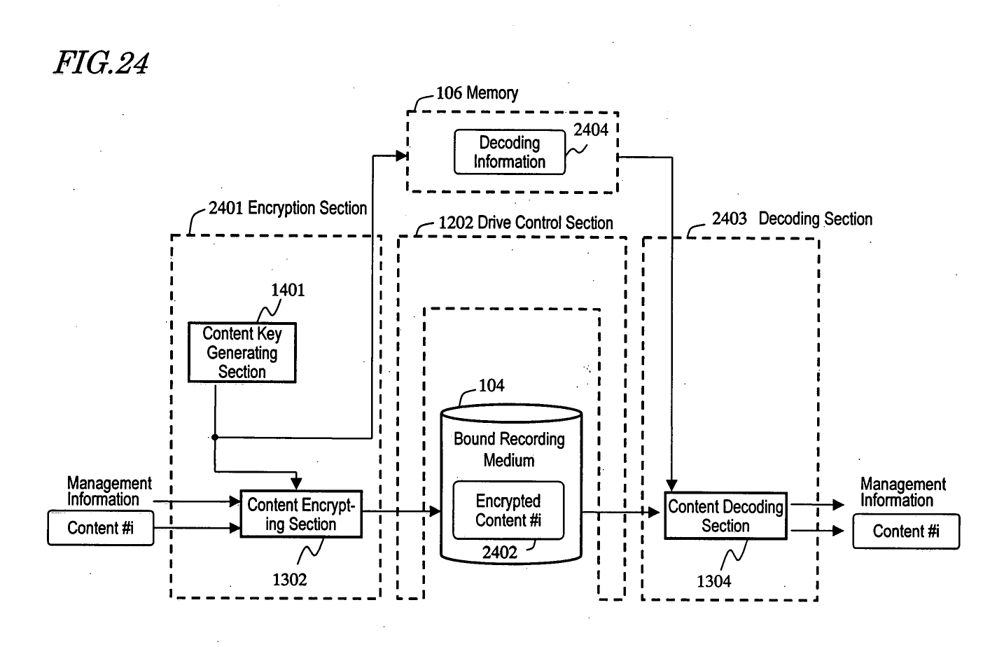

FIG. 23 shows an arrangement of functional blocks in a recorder 101 according to a second preferred embodiment of the present invention. The recorder 101 of this preferred embodiment controls the accessibility of a content by using “decoding information” instead of the “permission information” of the first preferred embodiment. That is to say, the “decoding information” is a type of access control information.

In FIG. 23, each component having the same function as the counterpart of the recorder of the first preferred embodiment (shown in FIG. 3, for example) is identified by the same reference numeral. In the following description of the second preferred embodiment, the functions and configurations of the recorder, which are identical with those of the recorder of the first preferred embodiment, will not be described again.

The encryption section 2401 of the recorder 101 encrypts a given content by a method that requires unique decoding information 2404 for each and every content. The bound recording medium 104 bound-records the encrypted content 2402. The memory 106 retains the decoding information 2404 by a method that denies any illegal access. The decoding section 2403 decodes the encrypted content 2402 with the decoding information 2404. The encryption section 2401 and the decoding section 2403 correspond to the CPU 21 shown in FIG. 2.

### 2-2. Operation of Recorder 101 in Outline

In accordance with the user's manipulations through the user interface section 112, the control section 111 controls the encryption section 2401, a drive control section 1202, the decoding section 2403, the memory 106, the recording section 108, the first read/write section 2801 and so on.

Specifically, on receiving a request to bound-record a content, the control section 111 makes the encryption section 2401 encrypt the content and also makes the drive control section 1202 bound-record the encrypted content on the bound recording medium 104. Furthermore, the control section 111 gets the decoding information 2404 of the encrypted content retained in the memory 106.

On the other hand, in response to a request to move a content, the control section 111 makes the drive control section 1202 read the encrypted content 2402 that has been bound-recorded on the bound recording medium 104 and gets the encrypted content decoded by the decoding section 2403 with the decoding information 2404 thereof only when the content's decoding information 2404 is present in the memory 106. Then, the control section 111 gets the decoded content recorded on the first storage medium 109 by the recording section. 108, and invalidates the content's decoding information 2404 that is retained in the memory 106.

In response to a request to erase a content, the control section 111 does not change the content's decoding information 2404 stored in the memory 106 but erases the encrypted content 2402 that has been bound-recorded on the bound recording medium 104.

Furthermore, in response to a request to back up a content, the control section 111 gets the content that has been bound-recorded on the drive control section 104 recorded by the first read/write section 2801 on the second storage medium 2802. In that case, the content's decoding information 2404 stored in the memory 106 is not changed.

Also, when a request to restore a content is received, the control section 111 gets the content that has been recorded on the second storage medium 2802 read by the read/write section 2801 and bound-recorded on the bound recording medium 104 again only if the content's decoding information 2404 stored in the memory 106 is available. In that case, the content's decoding information 2404 stored in the memory 106 is not changed, either. As used herein, “the content's decoding information 2404 is available” means that “the content is accessible”.

If the recorder 101 further includes either a display device (not shown) to present a content thereon or an output section (not shown), then the control section 111 may also accept a request to play back the content. When such a content playback request is received, the control section 111 operates only if the content's decoding information 2404 is available. More specifically, the control section 111 makes the drive control section 1202 read the content 2402 that has been bound-recorded on the bound recording medium 104, gets the content decoded by the decoding section 2403 and gets the content presented on the display device or output from the output section. In that case, the content's decoding information 2404 stored in the memory 106 is not changed, either.

If the recorder 101 further includes either a display device (not shown) to present a content thereon or an output section (not shown), then the control section 111 may also accept a request to play back the content. When such a content playback request is received, the control section 111 operates only if the content's decoding information 2404 is available. More specifically, the control section 111 makes the drive control section 1202 read the content 105 that has been bound-recorded on the bound recording medium 104, gets the content decoded by the decoding section 2403 and gets the content presented on the display device or output from the output section. In that case, the content's decoding information 2404 stored in the memory 106 is not changed, either.

### 2-3. Details of Respective Components of Recorder 101

FIG. 24 shows a more detailed configuration for the encryption section 2401 and the decoding section 2403. This configuration is used for encrypting and decoding a content by a method that requires unique decoding information for each single device. The memory 106 and drive control section 1202 are also shown for convenience sake.

The encryption section 2401 includes a key generating section 1401 and a content encrypting section 1302. The decoding section 2403 includes a content decoding section 1304. The functions of these components are identical in principle with those of the counterparts identified by the same names in FIG. 10.

More specifically, when a request to bound-record a content is received, the key generating section 1401 creates a random number to generate a unique content key with a predetermined bit length. In addition, every time generating the key, the key generating section 1401 also issues content identification information according to the number of items of the decoding information that have been generated so far. The content key and the content identification information are sent in combination as the decoding information 2404 to the memory 106 and retained there. The decoding information 2404 is generated for each single content, and retained in the memory 106 by a method that denies any illegal access. This retention method will be described in detail later.

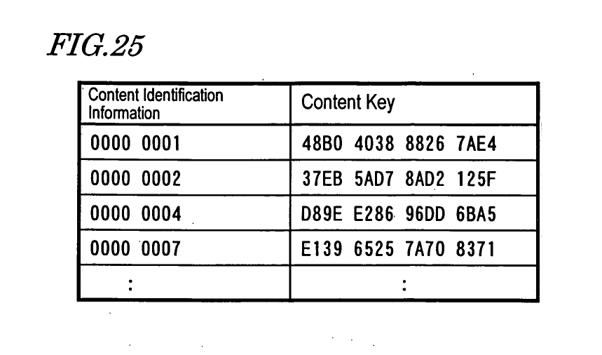

FIG. 25 shows a table with which multiple items of decoding information 2404 are registered. Each content key is retained in association with a piece of content identification information. And the content keys are arranged in the ascending order of the content identification information.

In this preferred embodiment, if a content has been moved, the decoding information is invalidated. More specifically, the decoding information associated with the moved content is erased. In the example shown in FIG. 25, for instance, there are no pieces of content identification information, of which the least significant digit is 3, 5 or 6, and their associated content keys. This means that the content associated with that content identification information has been moved and erased as a result of the move.

Optionally, the decoding information may also be not available by replacing the value of a content key with another value. Any arbitrary value may be used as the alternative value. For example, all bits of a content key to be made not available may be changed into zeros or ones. By setting a rule in advance that such values are not usable as a regular content key, it is easy to determine whether the key is available or not. Also, as in FIG. 12B, the number of items of the decoding information may be provided at the top of each item of the decoding information.

Referring back to FIG. 24, the content encrypting section 1302 encrypts an MPEG-2 partial TS representing a content with the content key and the management information. The encrypted content is bound-recorded on the bound recording medium 104 by the drive control section 1202. In this case, the recording format may be defined arbitrarily. If a management information file in which the management information is stored is generated, the management information file (not shown) is also bound-recorded on the bound recording medium 104 by the drive control section 1202.

Even if this encrypted content were backed up by the user on another medium, the content should be decoded only by the decoding section 1304 and therefore would not be accessible for any device but the recorder 101.

The encrypted content 240 bound-recorded is read by the drive control section 1202 when necessary. In addition, the decoding information 2404 (including the content key) is also read out from the memory 106. The decoding section 2403 decodes the encrypted content 240 with this content key into the original non-encrypted content. In the meantime, the associated management information is also read and decoded if necessary.

Alternatively, the encrypted content 2402 bound-recorded may be erased by the drive control section 1202 depending on the necessity. The erasing method is just as already described for the first preferred embodiment.

Next, a method of denying illegal access to the content's decoding information 2404 in the memory 106 will be described. For the first preferred embodiment, a method for preventing a third party from altering the permission information illegally by combining, or by not combining, the memory 106, the control section 111 and setting section 1303 together has been described. The same statement is also applicable to this preferred embodiment just by replacing the control section 111 and setting section 1303 with the encryption section 2401 and decoding section 2403, respectively.

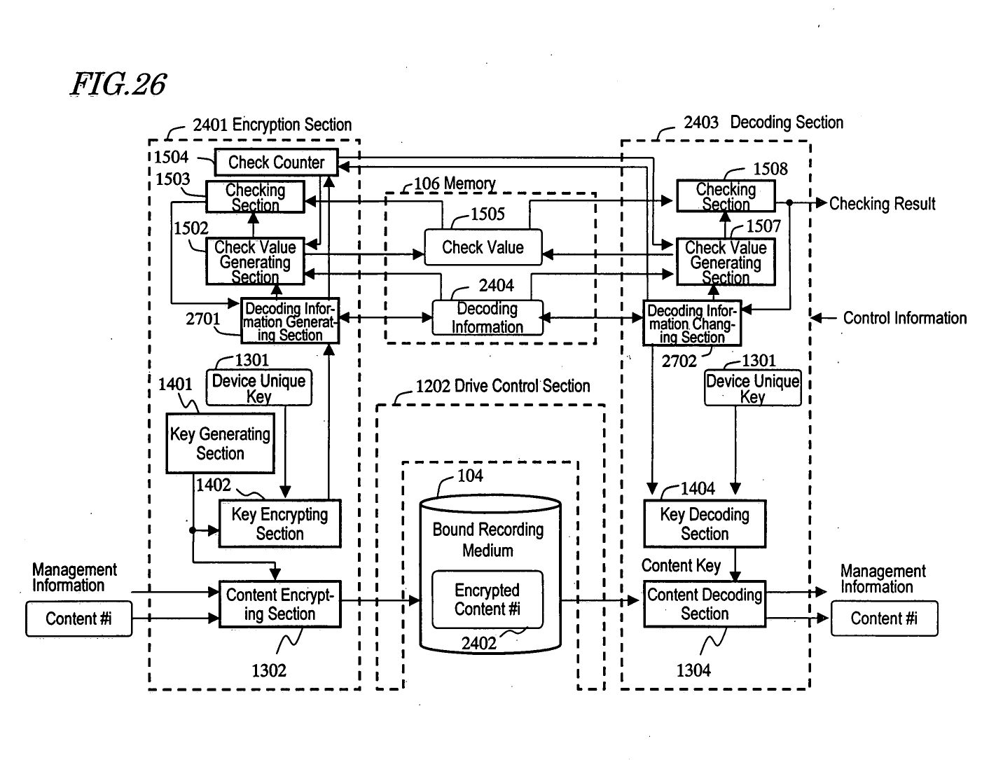

According to another method for deterring illegal alteration of content's decoding information, a check value may also be used. FIG. 26 shows a configuration that adopts an alteration deterring method using a check value. The check value is just as already described with reference to FIG. 11.

In FIG. 11, the check value is processed by the setting section 1303 in the encryption section 1201. In this preferred embodiment, however, no setting section is provided in the encryption section 2401. Thus, in FIG. 26, the check value processing is done inside the encryption section 2401.

Hereinafter, the difference between the configuration of the first preferred embodiment (shown in FIGS. 10 and 11) and that of this preferred embodiment (shown in FIG. 26) will be described. In FIG. 26, the encryption section 2401 further includes a decoding information generating section 2701 and the decoding section 2403 further includes a decoding information changing section 2702. The encryption section 2401 and the decoding section 2403 may be provided within the same semiconductor, for example, and are designed so as not be accessed illegally during the encryption processing and the check value processing, respectively. In this preferred embodiment, the processing is supposed to be carried out by using the configuration shown in FIG. 26.

### 2-4. Procedure of Operating Recorder 101

The processing of this preferred embodiment is similar to the processing done by the recorder of the first preferred embodiment (see FIG. 15). Although the permission information 107 is used in the first preferred embodiment, the decoding information 2404 is used instead of the permission information 107 in this preferred embodiment. Hereinafter, the bound-record, move, erase, backup and restore processing will be described in detail. The user is supposed to input a bound-record, move, erase, backup or restore request by way of the user interface section 112. A specific method of inputting a request through the user interface section 112 is just as already described for the first preferred embodiment.

### 2-5-1. Processing Responsive to Content Bound-Record Manipulation

When a content bound-record request is received from the user, the encryption section 2401 checks the decoding information 2404 for any illegal alterations that may have been done on the content so far.

The check value generating section 1502 reads the current decoding information 2404 that is already retained in the memory 106, generates a check value based on this decoding information 2404 and the value stored in the check counter 1504, and sends it to the checking section 1503. In response, the checking section 1503 reads the current check value 1505 that is stored in the memory 106 and compares it to the check value that has been generated by the checking, section 1503.

If these values do not agree with each other, it means that either the decoding information 2404 or the check value 1505 has been altered. Then, abnormality processing is carried out. The abnormality processing may be performed just as already described for the first preferred embodiment.

On the other hand, if the two values agree with each other, then it can be seen that the decoding information 2404 has never been altered. That is why the current decoding information 2404 may be used as it is. And the checking section 1503 notifies the decoding information generating section 2701 of this check result.

The key generating section 1401 generates a unique content key for each and every content. The content key generated is encrypted by the key encrypting section 1402 with the device unique key 1301. Then, the encrypted content key is sent to the decoding information generating section 2701.

Having been notified by the checking section 1503 that the check values agreed with each other as a result of the check, the decoding information generating section 2701 adds the encrypted content key to the current decoding information, thereby generating new decoding information. The decoding information generated is retained in the memory 106.

Also, the decoding information generating section 2701 notifies the check counter 1504 that it has generated the new decoding information. In response to this notification, the check counter 1504 updates its check count. The check value generating section 1502 generates a new check value based on the decoding information generated and the updated check count and gets it stored in the memory 106.

After that, the same processing is carried out as in the first preferred embodiment in response to the content bound-record request. Specifically, the control section 111 makes the digital broadcast receiving section 102 generate a partial TS and management information of that content. For example, if the digital_recording_control_data field of the content's digital copy control descriptor is “10” (meaning “copy one generation”), the content is encrypted by the encryption section 2401 and bound-recorded as “copy never” on the bound recording medium 104.

As a result of this processing, the content is bound-recorded and its decoding information is generated.

### 2-5-2. Processing Responsive to Content Move Manipulation

When a content move request is received from the user, first, the decoding section 2403 checks the decoding information 2404 for any alterations that may have been made so far. This processing step is the same as that of the processing to be done responsive to the bound-record request. Next, the checking section 1508 compares the current check value 1505 stored in the memory 106 to the check value that has been generated by the checking section 1508. Only when these two values agree with each other, the move processing is carried out.

The decoding section 2403 sends the decoding information (i.e., the encrypted content key) of the content, which has been designated as the content to move by way of the user interface section 112, to the key decoding section 1404 and gets the information decoded with the device unique key 1301. Also, the decoding section 2403 gets the encrypted content, which has been designated as the content to move, read from the bound recording medium 104 by way of the drive control section 1202 and gets the content decoded with the content key obtained from the key decoding section 1404. In the meantime, the management information is also decoded if necessary.

The control section 111 instructs the recording section 108 to move the decoded content to the first storage medium 109.

If the content could be copied onto the first storage medium 109, then control information notifying the fact is transmitted to the decoding section 2403. Then, the decoding information changing section 2702 makes that content's decoding information not available and stores it in the memory 106. Also, the decoding information changing section 2702 updates the check counter 1504 and sends the updated check count, along with the new decoding information, to the check value generating section 1507, thereby generating a new check value. Then, the new check value is also stored in the information storage section 106.

If the first storage medium 109 protects the content with a code, for example, then information that makes the content on the first storage medium 109 accessible (e.g., information about the key to decode the content's code) is written on the storage medium 109 after the decoding information and check value have been stored on the memory 106. Furthermore, the encrypted content that has been bound-recorded on the bound recording medium 104 may also be erased.

If the content could not be copied onto the first storage medium 109 due some defect thereof, then the user would be notified of the abnormality processing and the processing responsive to the move request should be ended without changing the decoding information (including the content key), the check counter value and the check value.

### 2-5-3. Processing Responsive to Content Playback Manipulation

When a request to play back a bound-recorded content is received, the decoding section 2403 checks the decoding information 2404 for any alterations that may have been done so far as in the processing step at the start of the bound recording operation. And if there are no alterations, the decoding section 2403 decodes the content that has been designated as a content to play back. The same decoding method is adopted as in the move processing. Then, the content is either presented on the display device or output from the output section. In this case, the count of the check counter 1504, the check value 1505 and the decoding information 2404 do not have to be changed.

### 2-5-4. Processing Responsive to Content Erase Manipulation

When a request to erase a bound-recorded content is received, the control section 111 instructs that the selected content be erased from the bound recording medium 104. In this case, the decoding information 2404 is not changed. That is why if the user removes the bound recording medium 104, connects it to another device (e.g., a personal computer), and restores a content, which has been backed up on another storage medium, onto the bound recording medium 104, the content becomes accessible for the recorder 101 again.

### 2-5-5. Processing Responsive to Content Backup Manipulation

In response to the instruction to start backing up the content, the decoding section 2403 checks the decoding information 2404 for any alterations that may have been done so far, i.e., determines whether the decoding information is available or not. If it is confirmed that the decoding information is available, the control section 111 makes the drive control section 1202 read the encrypted content 2402 from the bound recording medium 104 and gets the encrypted content recorded on the second storage medium 2802 by the read/write section 2801 without decoding it. Also, the management information file of that content, if any, is also recorded on the second storage medium 2802. In this case, to show clearly which device has made the backup, a predetermined value is encrypted with the device unique information and recorded at a prescribed location on the management information file. The content's decoding information 2404, retained in the memory 106, is not changed. Furthermore, if the content has also been designated as a content to erase, the content is deleted from the bound recording medium 104.

In the backup manipulation, the decoding information is not changed. Accordingly, if the content that has been backed up by the user on the second storage medium 2802 is restored onto the bound recording medium 104, that content becomes accessible for the recorder 101 again.

### 2-5-6. Processing Responsive to Content Restore Manipulation

In response to the instruction to start restoring the content, the decoding section 2403 also determines whether the decoding information 2404 is available or not. If it is confirmed that the decoding information is available, the control section 111 makes the read/write section 2801 read the encrypted content 2803 from the second storage medium 2802 and gets the encrypted content bound-recorded again on the bound recording medium 104 by the first read/write section 2801. Also, the management information file of that content, if any, is also recorded on the bound recording medium 104. The content's decoding information 2404, retained in the memory 106, is not changed.

Accordingly, if the content that has been backed up by the user on another storage medium is restored onto the bound recording medium 104, that content becomes accessible for the recorder 101 again.

In this preferred embodiment, when a content is either backed up or restored between the bound recording medium 104 and the second storage medium 2802, it is confirmed whether the content's decoding information is available. However, as this confirmation is made for the sake of user's convenience, the content may be backed up or restored without checking the content's decoding information. In that case, if the decoding information is not available when a content that has been restored onto the bound recording medium 104 is going to be played back or moved, then the content is no longer accessible.

### EMBODIMENT 3

A recorder according to a third preferred embodiment of the present invention includes not only all components of the recorder of the first preferred embodiment but also a second read/write section for backing up or restoring the permission information. The additional read/write section is provided mainly to cope with a situation where the memory 106 has become inoperative due to a trouble, for example.

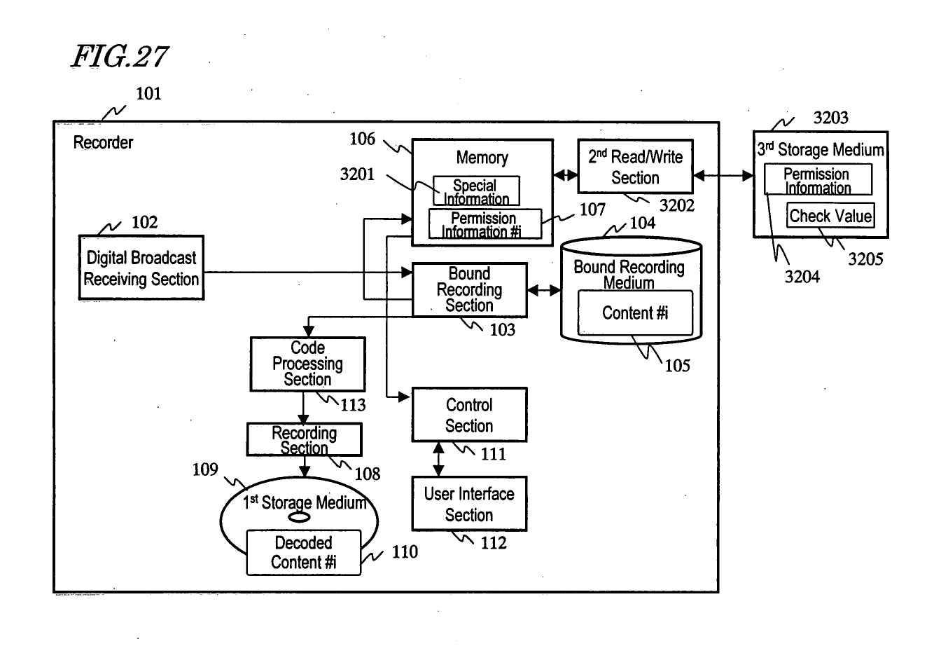

FIG. 27 shows an arrangement of functional blocks in the recorder 101 of this preferred embodiment. This recorder 101 further includes a second read/write section 3202. Also, the memory 106 further retains special information 3201. The illustration of the first read/write section 2801 and second storage medium 2802 is omitted from the recorder 101 of this preferred embodiment, which means that the recorder 101 may or may not include them.

The recorder 101 may back up the permission information on a third storage medium 3203 and restore the permission information that has been backed up. More specifically, the second read/write section 3202 of the recorder 101 records the permission information 107 in the memory 106 onto the third storage medium 3203 by a non-alterable method. The second read/write section 3202 further records a check value 3205 on the third storage medium 3203. Also, the second read/write section 3202 restores the permission information 3204 that has been recorded on the third storage medium 3203 into the memory 106.

The second read/write section 3202 corresponds to the CPU 21 shown in FIG. 2. Meanwhile, the third storage medium 3203 may be either a part of the DVD 28 or an SD memory card 29. If the third storage medium 3203 is a part of the DVD 28, a DVD drive 15a should be interposed between the second read/write section 3202 and the third storage medium 3203. On the other hand, if the third storage medium 3203 is an SD memory card 29, a memory card control section 27 needs to be provided between the second read/write section 3202 and the third storage medium 3203.

Hereinafter, a configuration and processing for backing up the permission information, which is retained in the memory 106, onto the third storage medium 3203 will be described.

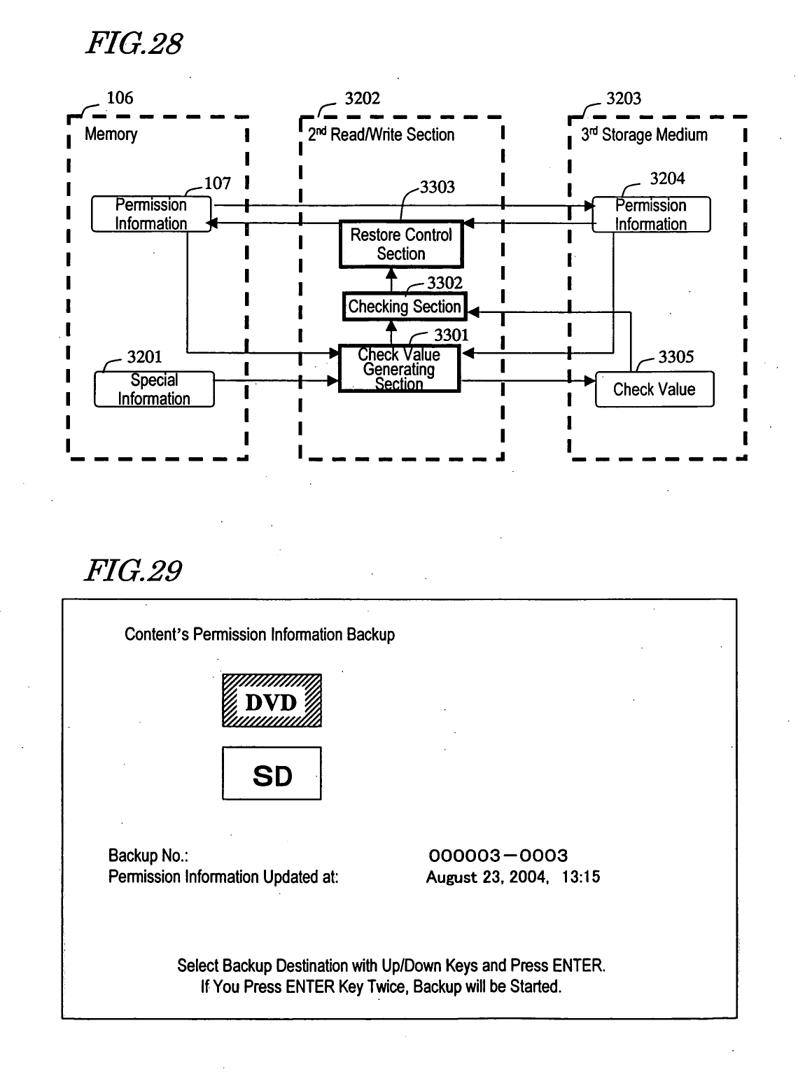

FIG. 28 shows more detailed configurations for the memory 106, second read/write section 3203 and third storage medium 3203. The special information 3201 is retained in the memory 106.

This special information 3201 is information that can be referred to by the second read/write section 3203 but that is not available for the user. As long as these conditions are satisfied, any value may be stored as the special information 3201. If a content has been moved successfully, the special information 3201 is updated into a new value. As will be described later, the special information 3201 is information for generating a check value and can be regarded as a sort of key information. The special information 3201 is also called a “nonce”.

The second read/write section 3203 includes a check value generating section 3301, a checking section 3302 and a restore control section 3303.

The check value generating section 3301 generates a check value based on either the permission information 107 in the memory 106 or the permission information 3204 on the third storage medium 3203 and on the special information 3201. This check value is recorded on the third storage medium 3203.

The checking section 3302 compares the check value generated by the check value generating section 3301 to the check value 3305 that has been recorded on the third storage medium 3203.

Based on the result of comparison made by the checking section 3302, the restore control section 3303 restores the permission information 3204, which has been recorded on the third storage medium 3203, into the memory 106.

In the example shown in FIG. 27, the special information 3201 is retained in the memory 106. However, as in the check counter 1504 shown in FIG. 11, the special information 3201 may also be retained in the setting section 1303.

First, the configuration shown in FIG. 28 will be described. After that, the processing of backing up the permission information on the third storage medium 3203 will be described.

The second read/write section 3202 records the permission information 107 on the third storage medium 3203. In this case, the management information such as the device's identification information, recording date and time, or the serial number of the backup recording (i.e., a backup number) may be recorded at a predetermined location of the permission information. These pieces of information are used to get the attribute information of the permission information when the permission information is restored.

The recorder 101 may also store the backup date and time of the permission information and the identification information of the third storage medium 3203, for example. The identification information of the third storage medium 3203 includes a medium unique number to be written on the storage medium during the manufacturing process thereof, the title or name of the medium to be input by the user during recording, and the content's title or name associated with the permission information.

If the permission information has been recorded successfully, a check value is generated based on the special information 3201 and the permission information 107. A check value that uses a unidirectional function is adopted as the check value. In a unidirectional function G(d1, d2) that needs arguments d1 and d2, a combination of the permission information to be checked and the special information is used as d1, the device unique key (not shown) is used as d2 and C=G(d1, d2) is used as a check value. The check value generated is recorded on the third storage medium 3203. To prevent the save/restore attack, the special information 3201 is updated into a new value by the control section 111 if at least the content move processing has been done successfully.

Next, the permission information backup manipulation may be carried out in the following procedure. First, the user gets a permission information backup screen displayed by using the remote controller 1905.

FIG. 29 shows an exemplary screen displayed for a permission information backup manipulation purpose. In FIG. 29, the option “DVD” is highlighted, showing that a DVD is currently selected. As there is another option “SD” besides “DVD”, it can be seen that the recorder 101 may be loaded with both a DVD and an SD memory card. The user may select one of these media as the third storage medium 3203.

On the screen, also shown are a backup number and a permission information update date and time. The six-digit numeral on the left-hand side of the hyphen of the backup number is associated with the special information 3201.

If a content has been moved successfully, the special information 3201 is updated into a new value. The value on the right-hand side of the hyphen is updated if the permission information is changed while the special information 3201 has a constant value (i.e., after a content has been moved and before the next content is moved). This value may be updated when a new content is bound-recorded, for example. The permission information update date and time is also updated if the permission information is changed after a content has been moved and before the next content is moved. The value on the right-hand side of the hyphen is recorded along with the special information.

On the permission information backup screen, first, the user selects a storage medium as the destination of the backup operation by using the remote controller 1905. When the storage medium is selected, the second read/write section 3202 sees if the third storage medium 3203 as the destination of the permission information backup operation still has sufficient capacity available. If the remaining capacity is insufficient, an alert message is displayed to prevent the user from selecting that storage medium.

If the enter key 1911 is pressed twice back to back, then a confirmation message “permission information backup is about to start; press enter key again” is displayed on the bottom of the screen. And when the user presses the enter key 1911 once again, an instruction to back up the permission information onto the third storage medium 3203 is issued.

In response to the instruction to start backing up the permission information, the second read/write section 3202 records the permission information and the check value on the third storage medium 3203.

Hereinafter, the processing of restoring the permission information that has been backed up on the third storage medium 3203 will be described. First, the second read/write section 3202 judges by the check value that has been recorded on the third storage medium 3203 whether or not the permission information 3204 is updated and non-altered.

The check value generating section 3301 reads the permission information 3304 and generates a check value based on the permission information 3304 as well as the special information 3201. The checking section 3302 compares the check value generated to the check value 3305 that has been recorded on the third storage medium 3203, and notifies the restore control section 3303 of the result of comparison.

If these values agree with each other, then the permission information 3204 recorded on the third storage medium 3203 is regarded as updated and non-altered, and is stored in the memory 106.

If these values do not agree with each other, however, the permission information 3204 recorded on the third storage medium 3203 is regarded as either non-updated or altered. Thus, an alert message is displayed on the user interface section 112 and the remaining processing is canceled.

The check value generating section 3301 and checking section 3302 that are included in the second read/write section 3202 need to be designed such that the details or the interim products of the processing are not accessed illegally. For example, these sections 3301 and 3302 and the encryption section 1201 and decoding section 1203 may be integrated together into a single LSI.

The permission information restore manipulation may be carried out in the following procedure. First, the user gets a permission information restore screen displayed by using the remote controller 1905.

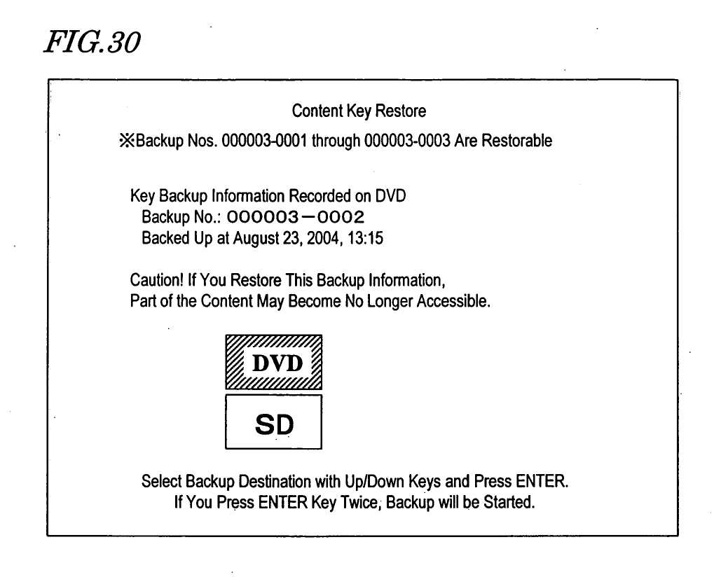

FIG. 30 shows an exemplary screen displayed for a permission information restore manipulation purpose. On the screen, highlighted is the type of a storage medium as the source of the permission information restore operation as shown in FIG. 30.

When the type of a storage medium is highlighted as the source of the permission information restore operation, the identification information of the device is confirmed by reference to the management information of the permission information that is backed up on the third storage medium 3203. If the device's identification information is not available, then it can be seen that the content backed up on the third storage medium 3203 was not backed up by that device. Thus, an alert message that the content was backed up by another device is displayed on the user interface section 112, thereby aborting the permission information restore operation. On the other hand, if the predetermined value has been obtained, then the content was backed up by that device. Thus, the backup number and the recording date and time are acquired. Furthermore, it is determined by the check value 3305 whether or not the permission information 3204 is updated and non-altered. If the answer is YES, then the type of the storage medium may be presented as the source of the permission information restore operation. Otherwise, the type of the storage medium will not be presented.

Furthermore, the portion of the backup number of the permission information on the right-hand side of the hyphen is checked. If this portion is different from the updated value that has been recorded on the device, then it means that a new content was bound-recorded after a content was moved and before the next content was moved. That is to say, although restoring the permission information is permitted, there is no permission information for the newly bound-recorded content, and therefore, these contents might be no longer accessible. Thus, an alert message pointing out this possibility is displayed to the user by way of the user interface section 112.

In FIG. 30, information about restorable storage media is provided by a message such as “backup Nos. 000003-0001 through 000003-0003 are restorable”. However, no matter whether the third storage medium 3203 is usable or not, this information may be presented based on the identification information of the storage medium that has been backed up on the recorder 101. Also, although the backup numbers are shown in FIG. 30, the titles of the storage media as recorded in the recorder 101 may be shown instead.

On the permission information restore screen, first, the user selects a storage medium as the source of the permission information restore operation by using the remote controller 1905. If the enter key 1911 is pressed in this state, the choice of the storage medium is determined.

If the enter key 1911 is pressed twice back to back, then a confirmation message “permission information restore is about to start; press enter key again” is displayed on the bottom of the screen. And when the user presses the enter key 1911 once again, an instruction to start restoring the permission information 3204 from the third storage medium 3203 into the memory 106 is issued.

In response to the instruction to start restoring the permission information, the second read/write section 3203 is made to read the permission information 3204 recorded on the third storage medium 3203 and retain it in the memory 106. Also, only when the portion of the backup number on the right-hand side of the hyphen in the memory 106 is different from the updated value recorded in the device, the check value 1504 is recalculated based on the restored permission information 107 and the recalculated value is retained in the memory 106. This processing is carried out because the disagreement of check values to be caused when the restored permission information 107 is used needs to be resolved. As a result of this recalculation processing, however, the content that has been bound-recorded after the permission information was backed up becomes no longer accessible.

In this preferred embodiment, when the permission information is restored from the third storage medium 3203 into the memory 106, it is confirmed in advance that the permission information is restorable. However, as this confirmation is made for the sake of user's convenience, the restore operation may be performed without checking the permission information. In that case, if the check values disagree when the permission information is going to be restored from the third storage medium 3203, then the information is no longer restorable.

According to this preferred embodiment, not only the content but also the permission information can be backed up. That is why even if the information in the memory were lost due to an accident, for example, both the permission information and the content can be restored.

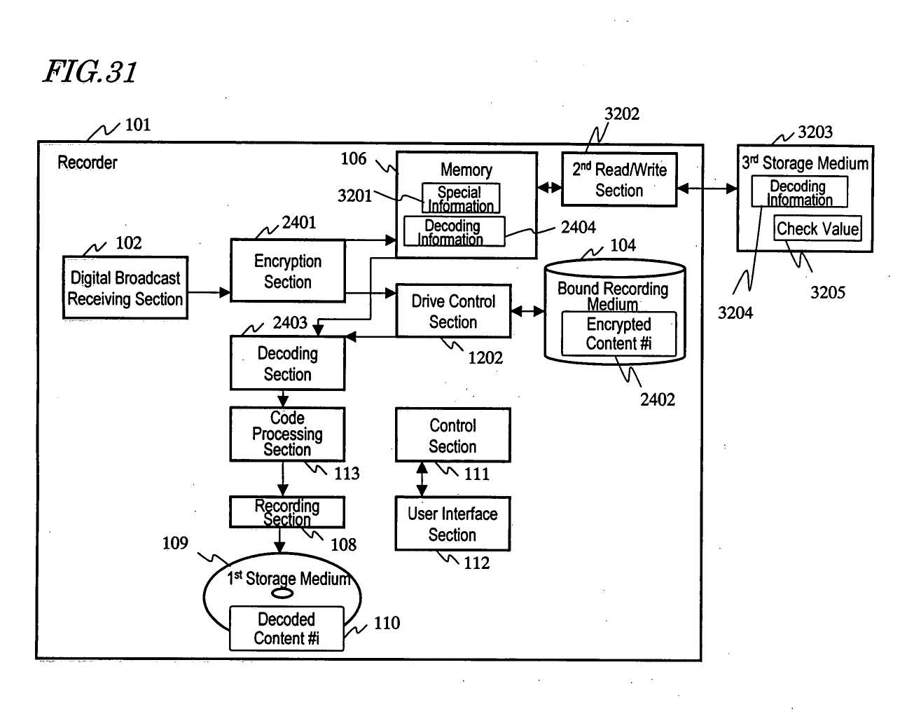

In the preferred embodiment described above, it has been described how to back up and restore the permission information. Alternatively, the decoding information of the second preferred embodiment may also be backed up and restored. FIG. 31 shows a configuration for backing up and restoring the decoding information 2404 onto the third storage medium 3203. The operation of this recorder can be easily understood just by replacing the permission information with the decoding information in the description of the recorder 101 of this preferred embodiment. Thus, the description of the respective components and the operation will be omitted herein. It should be noted, however, that illegal access to the decoding information should also be denied even if the decoding information has been backed up. That is why in a situation where non-encrypted decoding information is retained by such a method that denies access to the memory 106, the decoding information needs to be given an additional protection by encryption, for example, when recorded on the third storage medium.

In the preferred embodiment described above, the permission information is supposed to be backed up at the timing that has been specified by the user by way of the user interface section 112. However, the backup may also be made at any other time. For example, if the accessibility state has been changed when the third storage medium 3203 is ready to record (i.e., a recordable medium has been loaded into either a medium drive or a slot), then the permission information may be backed up automatically.

Optionally, when the third storage medium 3203 is loaded, the contents recorded on the medium may be checked. And if the permission information has not been backed up or was backed up a long time ago, then the updated permission information may be backed up automatically. The user may also choose, by way of the user interface section 112, whether such an automatic backup should be made or not. By getting the permission information backed up automatically, it is possible to recover any loss that may be incurred at any time due to a trouble of the memory 106.

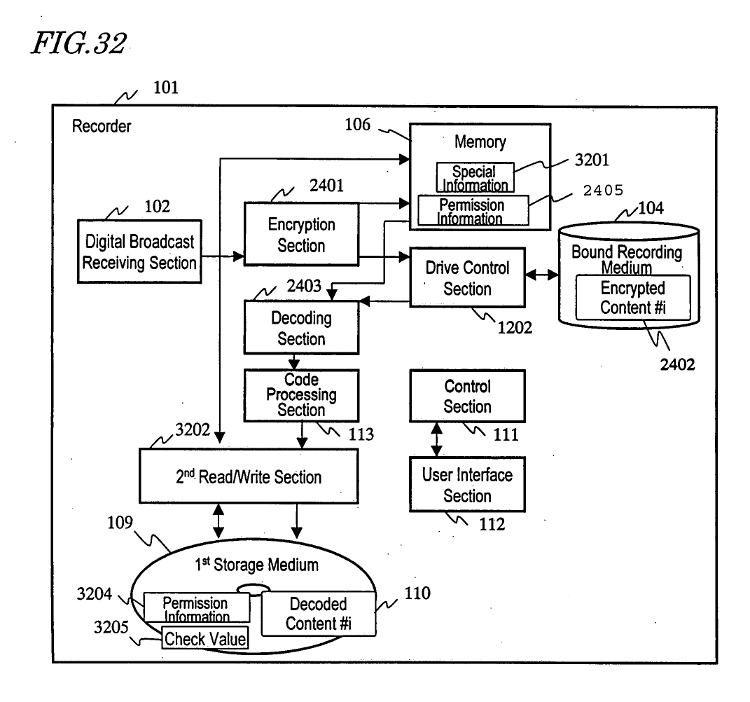

Also, in the preferred embodiment described above, the third storage medium 3203 to back up the permission information is supposed to be a separate medium. Alternatively, the permission information may also be backed up on the first storage medium 109. FIG. 32 shows an exemplary configuration for backing up the permission information on the first storage medium 109. For the same reasons as in FIG. 27, the illustration of the first read/write section 2801 and the second storage medium 2802 is omitted.

The second read/write section 3203 corresponds to the DVD drive 15a shown in FIG. 2 and the first storage medium 109 corresponds to the DVD 28.

In the recorder 101 shown in FIG. 32, writing when a decoded content is moved onto the first storage medium 109 and reading and writing when the permission information and check value are backed up or restored are performed by the second read/write section 3202. In this case, if the accessibility state has been changed when a drive or slot for the first storage medium 109 is loaded with a recordable medium, the permission information may be backed up automatically.

Optionally, when the first storage medium 109 is loaded, the contents recorded on the medium may be checked. And if the permission information has not been backed up or was backed up a long time ago, then the updated permission information may be backed up automatically. The user may also choose, by way of the user interface section 112, whether such an automatic backup should be made or not.

By using a single storage medium as the storage medium to back up the permission information and the storage medium to which the bound-recorded content should be moved, the same drive (i.e., the second read/write section 3202) may be used in common for the storage medium. As a result, the size and price of the device can be reduced.

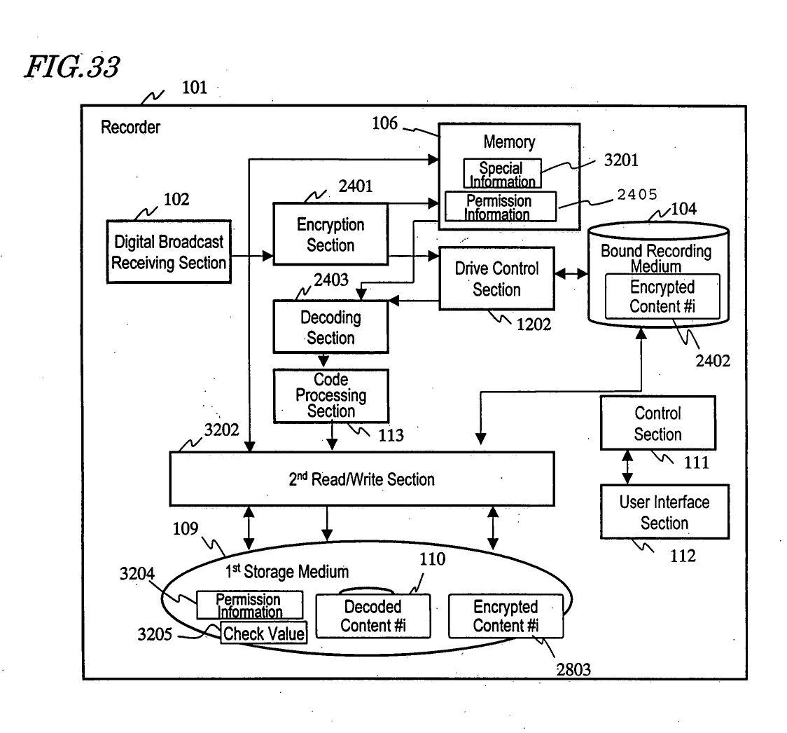

Furthermore, various types of information may be moved and backed up onto the first storage medium 109. For example, FIG. 33 shows an exemplary configuration for moving a content onto the first storage medium 109 and for backing up the permission information 2404 and the encrypted content on the bound recording medium 104 onto the first storage medium 109. In FIG. 33, the second read/write section 3203 corresponds to the DVD drive 15a shown in FIG. 2 and the first storage medium 109 corresponds to the DVD 28.

In FIG. 33, writing when a decoded content is moved onto the first storage medium 109, reading and writing when the permission information 3204 and check value 3205 are backed up or restored, and reading and writing of the encrypted content 2402 that has been bound-recorded on the bound recording medium 104 are performed by the second read/write section 3202. In this case, if the permission information 2404 has been changed when a drive or slot for the first storage medium 109 is loaded with a recordable medium, the permission information 2404 may be backed up automatically. Optionally, when the first storage medium 109 is loaded, the contents recorded on the medium may be checked. And if the permission information has not been backed up or was backed up a long time ago, then the updated permission information may be backed up automatically. The user may also choose, by way of the user interface section 112, whether such an automatic backup should be made or not.

By using a single storage medium as the storage medium to back up the permission information, as the storage medium to which the bound-recorded content should be moved, and as the storage medium to back up the bound-recorded content, the same drive (i.e., the second read/write section 3202) may be used in common for the storage medium. As a result, the size and price of the device can be reduced. Also, by getting the permission information backed up automatically, it is possible to recover any loss that may be incurred at any time due to a trouble of the memory 106.

In the first through third preferred embodiments described above, the first storage medium 109 is supposed to be a DVD-RAM, a DVD-RW or a DVD-R and the content is supposed to be encrypted and recorded by the CPRM method. However, the present invention is in no way limited to those specific preferred embodiments as described above.

As another example, a configuration for recording an encrypted content on an SD memory card by the CPRM method will be described. Unlike a DVD, an SD memory card can store a plurality of encrypted title keys thereon. That is why by adopting the same coding method as that of the SD memory card for the bound recording medium 104, there is no need to convert the codes and a move can be made quickly.

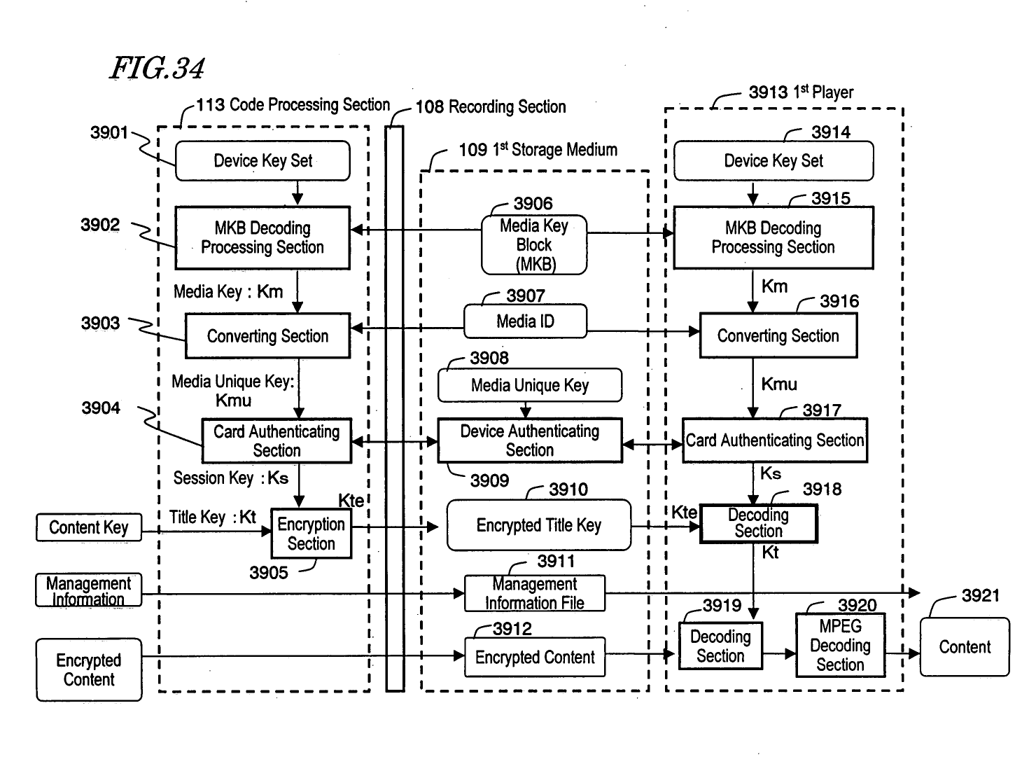

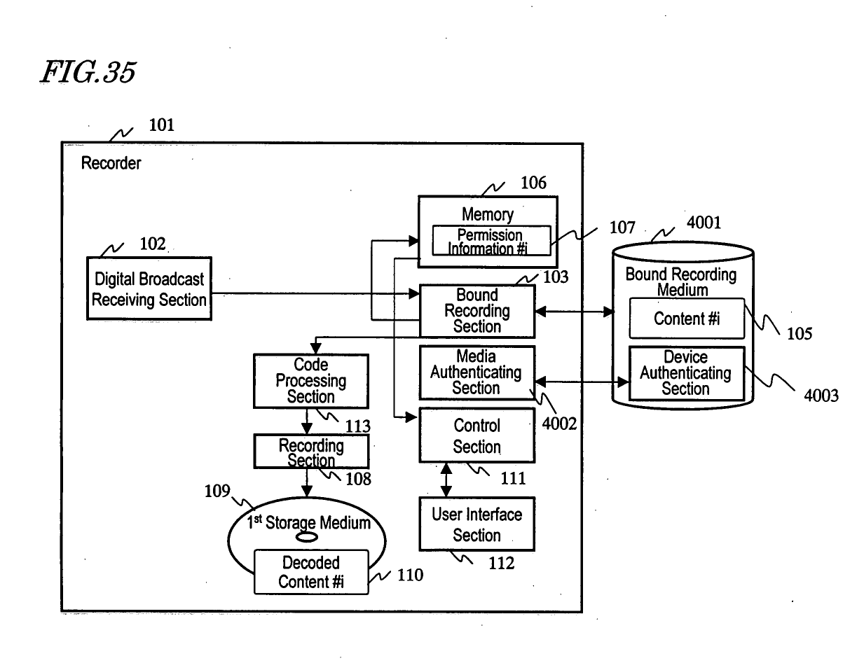

FIG. 34 shows a modified configuration for the code processing section 113 shown in FIG. 13. This modified example is adopted when an SD memory card is used as the first bound recording medium 109 shown in FIG. 3.

The code processing section 113 includes a device key set 3901, an MKB decoding processing section 3902, a converting section 3903, a card authenticating section 3904, and an encryption section 3905. The MKB decoding processing section 3902 generates a media key Km based on a media key block (MKB) 3906 and the device key set 3901. The converting section 3903 converts the media key Km with the media ID 3907, thereby generating a media unique key Kmu. The card authenticating section 3904 authenticates the card with the media unique key Kmu. The encryption section 3905 encrypts the title key with the media unique key Kmu.

The first storage medium 109 includes the media key block (MKB) 3906, the media ID 3907, the media unique key Kmu 3908, a device authenticating section 3909 for authenticating the device with the media unique key Kmu, an encrypted title key 3910, a management information file 3911, and an encrypted content 3912.

The MKB 3906 is data like a “cryptographic key ring” so to speak, which is a collection of media keys that have been encrypted with various device keys. The MKB 3906 is written on the first storage medium 109 by a non-alterable method when the storage medium is manufactured. The MKB is produced based on the data that has been figured out with a new media key Km every time a predetermined number of media (e.g., one hundred thousand as for SD memory cards) are manufactured. The media ID is data that is uniquely allocated to each storage medium and is written on the first storage medium 109 by a non-alterable technique when the storage medium is manufactured. The media unique key Kmu is a key that has been generated by converting the media key with the media ID. The media unique key Kmu has a unique value from one medium to another and cannot be read or written directly outside of the card.

The second player 3913 includes a device key set 3914, an MKB decoding processing section 3915, a converting section 3916, a card authenticating section 3917, decoding sections 3918 and 3919, and an MPEG decoding section 3920. The MKB decoding processing section 3915 generates a media key Km based on the media key block (MKB) 3906 and device key set 3914. The converting section 3916 converts the media key Km with the media ID 3907, thereby generating a media unique key Kmu. The card authenticating section 3917 authenticates a given card with the media unique key Kmu. The decoding section 3918 decodes the encrypted title key with a session key obtained during the authentication process. The decoding section 3919 decodes the encrypted content 3912 with the title key Kt. And the MPEG decoding section 3920 decodes the decoded content (such as an MPEG2-PS).

In FIG. 34, the second player 3913 is shown for convenience sake. However, the second player 3913 does not have to be provided separately from the recorder 101. A normal recorder usually has a playback function, too. Thus, the second player 3913 can be regarded as substantially included in the recorder 101.

Hereinafter, the operation of moving a partial TS representing a content from the bound recording medium 104 to the first storage medium 109 by way of the recording section 108 will be described.

The move operation is carried out in the following procedure, which includes the processing steps of: (1) cryptographic key preprocessing; (2) recording the encrypted content 3912 on the first storage medium 109; (3) changing the permission information (into “inaccessible”); and (4) recording the access information for the encrypted content 3912 and the encrypted title key 3910 on the first storage medium 109 and making the content readily accessible.

First, the cryptographic key preprocessing will be described. However, the same processing steps are carried out as already described with reference to FIG. 13 before the storage medium's own media unique key Kmu is generated. And the description thereof will be omitted herein.

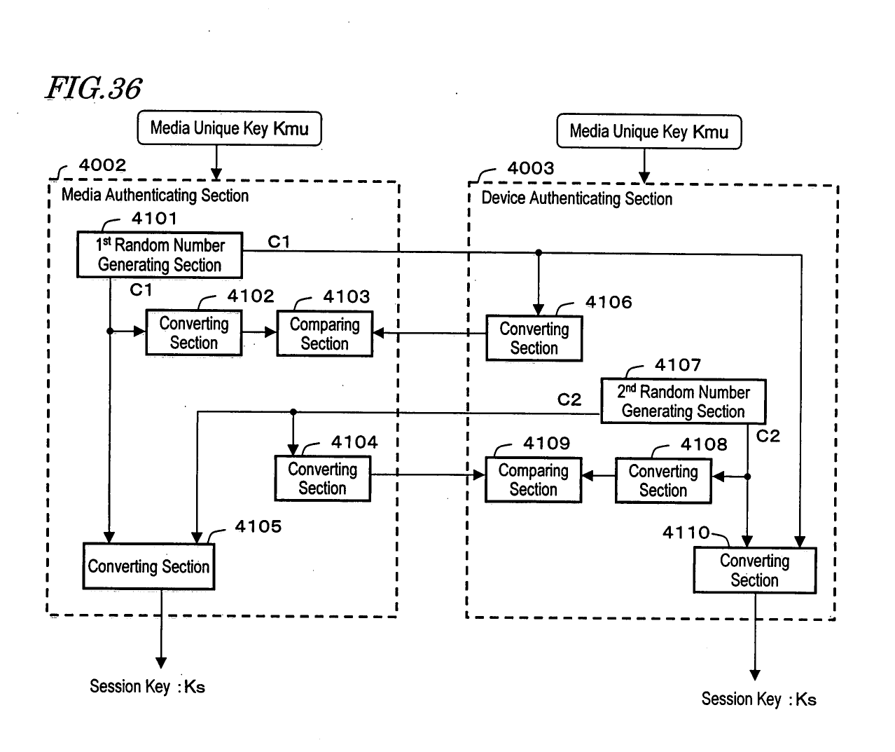

The recording section 108 and the first storage medium 109 authenticate each other as proper device or card by using the media unique key Kmu at the card authenticating section 3904 and the device authenticating section 3909. The authentication will be described later with reference to FIG. 36. In this authentication process, the card authenticating section 3904 and the device authenticating section 3909 exchange random numbers and then generate a session key Ks by using them. The cryptographic key preprocessing is done in this manner.

The encrypted content, etc., may be recorded on the first storage medium 109 using the cryptographic key in the following procedure.

If the first storage medium 109 is an SD memory card, the area on the first storage medium 109 in which the encrypted title key 3910 is recorded has a capacity to store a plurality of encrypted title keys. Thus, the content key that was used to encrypt and record the content on the bound recording medium 104 may be used as the title key Kt as it is. The code processing section 113 reads the encrypted MPEG2-PS data from the bound recording medium 104. The title key that was used to encrypt this file will be recorded later as the encrypted title key 3910 on the first storage medium 109. For that reason, the encrypted MPEG2-PS in the first data file 107 can be recorded as it is in the storage area of the encrypted content 3912 of the first storage medium 109. In that case, there is no need to perform the re-encryption process and the content just needs to be read out from the bound recording medium 104 and recorded on the first storage medium 109. Consequently, the recording process can be speeded up. Meanwhile, a portion of the management information is stored in the management information file 3911.

Thereafter, that content's permission information in the memory 106 is changed into “inaccessible” just as already described above. As a result, the content becomes no longer accessible.

The encryption section 3905 reads the decoded content key. The title key Kt is encrypted by the encryption section 3905 with the session key Ks. A C2 code is used as the code.

The code processing section 113 records the title key Kte that has been encrypted by the encryption section 3905 in the area for the encrypted title key 3910 on the first storage medium 109.

As a result, the content on the first storage medium 109 becomes accessible again. The drive control section 1202 may delete the encrypted content 1204 that has been made no longer accessible.

When the operation of moving the content from the bound recording medium 104 onto the first storage medium 109 is finished, the management information file and encrypted content on the bound recording medium 104 will have been made non-accessible. Thus, the management information file and encrypted content may be deleted to maintain the bound-recording capacity of the bound recording medium 104.

However, the first storage medium 109, for example, may have a function of moving the content to yet another bound recording medium or storage medium just like an SD memory card. In that case, the permission information 107 retained in the memory 106 just needs to be made not available but the encrypted content may be left as it is without being deleted. Then, if the content is moved back from the first storage medium 109 to the bound recording medium 104, the move back can be completed quickly just by making the permission information available again.

In that case, the identification information of the encrypted content and the media ID 3907 of the first storage medium 109, to which the content has been moved, may be stored in a non-user-accessible system area of the bound recording medium 104 and may be used at the time of a move back operation to determine whether the move back has been requested.

If the user is going to move back the first or second data file 107 or 109 that has once been moved onto the first storage medium 109, then the user stores his or her plan in the system area of the bound recording medium 104 and the bound recording medium 104 performs a control so as to make the encrypted content not accessible but not to delete it.

The content that has been moved onto the first storage medium 109 successfully can be played back by the second player 3913. In playing back the content, the title key Kt is decoded using the device key set 3914, MKB decoding processing section 3915, converting section 3916, card authenticating section 3917 and decoding section 3918 and the encrypted content 3912 is decoded by the decoding section 3919 using the title key Kt. The resultant MPEG2-PS stream is decoded by the MPEG decoding section 3920 into a baseband signal representing the content 3921.

For the first through third preferred embodiments, an example in which the bound recording medium 104 is built in the recorder 101 has been described. However, the bound recording medium 104 does not always have to be built in. For example, an external bound recording medium, which performs mutual authentication with the recorder 101 and which permits the user to access the bound-recorded data only when the authentication is done, may also be used.

FIG. 35 shows an example in which the bound recording medium 104 shown in FIG. 3 is arranged outside. In FIG. 35, each component having the same function as the counterpart shown in FIG. 3 is identified by the same reference numeral and the description thereof will be omitted herein.

The recorder 101 includes a media authenticating section 4002 and the bound recording medium 4001 includes a device authenticating section 4003.

FIG. 36 shows detailed configurations for the media authenticating section 4002 and device authenticating section 4003. The media authenticating section 4002 and device authenticating section 4003 authenticate each other with the media unique key shown in FIG. 13 or 34. If the authentication has been done successfully, a session key is generated. The session key is used to read or bound-record a content between the bound recording processing section 103 and the bound recording medium. The component for generating the media unique key is not shown in FIG. 36 but may be the same as the counterpart shown in FIG. 13 or 34.

The media authenticating section 4002 includes a first random number generating section 4101, converting sections 4102, 4014 and 4015 and a comparing section 4103. The first random number generating section 4101 generates a random number C1. The converting section 4102 converts the random number C1 and the media unique key Kmu with a unidirectional function. The comparing section 4103 compares the outputs of the converting sections 4102 and 4106 to each other. The converting section 4104 converts a random number C2 and the media unique key Kmu with the unidirectional function. And the converting section 4105 converts the random numbers C1 and C2 with the unidirectional function, thereby generating a session key Ks.

On the other hand, the device authenticating section 4003 includes converting sections 4106, 4108 and 4110, a random number generating section 4107 and a comparing section 4109. The converting section 4106 converts the random number C1 and the media unique key Kmu with a unidirectional function. The random number generating section 4107 generates a random number C2. The converting section 4108i converts the random number C2 and the media unique key Kmu with the unidirectional function. The comparing section 4109 compares the outputs of the converting sections 4104 and 4108 to each other. And the converting section 4110 converts the random numbers C1 and C2 with the unidirectional function, thereby generating a session key Ks.

Hereinafter, the procedure of mutual authentication will be described.

First, the recorder 101 authenticates the bound recording medium 104. Specifically, the media authenticating section 4002 gets the random number C1 generated by the first random number generating section 4101. The random number C1 is transmitted to not only the converting section 4102 but also the device authenticating section 4003 as well. The converting section 4102 uses the random number C1 and the media unique key Kmu as two inputs for a unidirectional function G and derives G (C1, Kmu) as the converted output. In the same way, the converting section 4106 in the device authenticating section 4003 also uses the random number C1 and the media unique key Kmu as two inputs for the unidirectional function G and derives G (C1, Kmu) as the converted output. The converted output derived by the converting section 4106 is sent back from the device authenticating section 4003 to the media authenticating section 4002 as a response to the random number C1. This response is compared by the comparing section 4103 in the media authenticating section 4002 to the converted output derived by the converting section 4102 in the media authenticating section 4002. If these two values agree with each other, then it means that the recorder 101 has authenticated the bound recording medium 4001 as a regular medium. If no response is returned by the device authenticating section 4003 within a predetermined amount of time or if the values do not agree with each other as a result of the comparison, then it means that some problem happened during the process of generating the media unique key or during the authenticating process described above. As a result, the authentication fails and illegal access is denied.

Next, the bound recording medium 104 authenticates the recorder 101. Specifically, the device authenticating section 4003 gets the random number C2 generated by the second random number generating section 4107. The random number C2 is transmitted to not only the converting section 4108 but also the media authenticating section 4002 as well. The converting section 4108 uses the random number C2 and the media unique key Kmu as two inputs for a unidirectional function G and derives G (C2, Kmu) as the converted output. In the same way, the converting section 4104 in the media authenticating section 4002 also uses the random number C2 and the media unique key Kmu as two inputs for the unidirectional function G and derives G (C2, Kmu) as the converted output. The converted output derived by the converting section 4104 is sent back from the media authenticating section 4002 to the device authenticating section 4003 as a response to the random number C2. This response is compared by the comparing section 4109 in the device authenticating section 4003 to the converted output derived by the converting section 4108 in the device authenticating section 4003. If these two values agree with each other, then it means that the bound recording medium 4001 has authenticated the recorder 101 as a regular device. If no response is returned by the media authenticating section 4002 within a predetermined amount of time or if the values do not agree with each other as a result of the comparison, then it means that some problem happened during the process of generating the media unique key or during the authenticating process described above. As a result, the authentication fails and illegal access is denied.

If the bound recording medium 4001 and the recorder 101 have authenticated each other successfully, then the random numbers C1 and C2 are converted by their respective converting sections 4105 and 4106 with the unidirectional functions, thereby obtaining a converted output G (C1, C2) as a session key Ks. The session key Ks is used as a cryptographic key to encrypt a content or its associated information to be transmitted or received between the recorder 101 and the bound recording medium 4001. The session key Ks changes into a different value every time the mutual authentication is made. Accordingly, even if a communication between the recorder 101 and the bound recording medium 4001 is intercepted, bound-recorded in another device, and then used at a different occasion in an attempt to fake as a regular device or medium, the communication cannot be decoded properly on the receiving end because the cryptographic key has already changed. As a result, such an illegal access can be denied.

By using the mutual authentication and the session key generated during its process in this manner, illegal access to the bound recording medium 104 can be blocked.

In the first and second preferred embodiments described above, the second storage medium 2802 for backing up the content that has been bound-recorded on the bound recording medium 104 has its content protected by encryption in order to block every illegal access. However, mutual authentication can also be adopted as in FIG. 35.

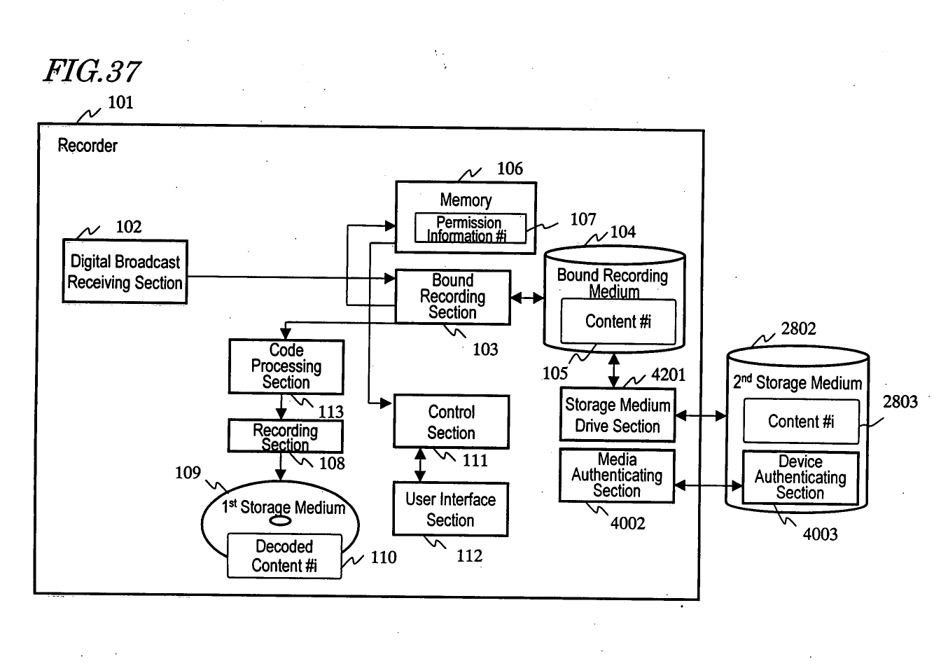

FIG. 37 shows an arrangement of functional blocks for a recorder 101 and a second storage medium 2802 that realize a backup by mutual authentication. In FIG. 37, each component having the same function as the counterpart shown in FIG. 3 is identified by the same reference numeral and the description thereof will be omitted herein. Also, any component that is also shown in FIG. 35 is identified by the reference numeral used in FIG. 35. The recorder 101 shown in FIG. 37 includes a storage medium drive section 4201.

The mutual authentication can be made in the same procedure as that described with reference to FIG. 35 and 36. By encrypting information (such as a content and its associated information) exchanged between the storage medium drive section 4201 and the second storage medium 2802 with the session key Ks obtained by the mutual authentication, illegal access to the content that has been recorded on the second storage medium 2802 can be blocked.

For the first and second preferred embodiments, an example of restoring an encrypted content, which has been recorded on the second storage medium 2802, onto the bound recording medium 104 has been described. However, the encrypted content does not have to be restored onto the bound recording medium 104 but may be played back directly or moved onto the first storage medium 109. If the content is played back directly or moved, then the content can be processed irrespective of the remaining capacity of the bound recording medium 104. This choice may be given to the user by providing “direct playback” and “move” options for the restore screen shown in FIG. 22, for example.

In each of the first and second preferred embodiments described above, the first read/write section may be designed so as to handle a number of storage media 2802 of the second type at the same time. More specifically, if the storage media of the second type are disk media, then a number of disk media may be controlled collectively by using a disk drive of a magazine type that can house the disk media at the same time. As a result, even a content, of which the data size is too big to be stored on a single disk medium, can be automatically split into a number of portions and backed up on the same number of disks. Also, the split and backed-up portions of the content may be restored, played back or moved back to back. Particularly, if a high-resolution video has been bound-recorded on the bound recording medium 104, the content can be backed up on a single DVD only partially for as short as 20 to 30 minutes. By using a magazine-type drive, however, the content can be backed up for approximately two hours. Consequently, a movie may be backed up without causing unnecessary stress to the user.

Recently, techniques called “checkout” and “check-in” have been known as a method for making a content that has been bound-recorded on a bound recording medium usable on another medium. For example, the “checkout” and “check-in” are used in SD audio, which is one of applications that use an SD memory card.

The checkout/check-in principle will be described. First, a counter is provided for a content that has been bound-recorded in the bound recording processing section. And when the content is bound-recorded, the count of the counter is set to a predetermined value (e.g., three). Then, every time the content is copied onto another storage medium, the count is decremented by one. To copy a content onto another storage medium is called making a “checkout”.

When making a checkout, not only the content itself but also the content's identification information are written on another storage medium by a non-alterable method. Since the identification information includes the device's own ID, the device that has made a checkout of that content can be identified without fail. As used herein, the “non-alterable method” may refer to writing information onto a secret area on an SD memory card, for example. The “secret area” means an area that is available for reading and writing for only a device that has passed the mutual authentication and is not available for direct reading or writing for the user. The checkout can be made until the count reaches zero.

Conversely, to return a content that has been checked out onto another storage medium to its original bound recording processing section is called making a “check-in”. The check-in can be made only onto the medium from which the content was checked out. That is to say, the device, including the medium on which the check-in is going to be made, confirms, by the device's own ID included in the content's identification information, if that content was checked out from the device before the check-in is permitted. And only when it is confirmed that the content was actually checked out of that device, the device permits the check-in.

Once the check-in has been made, the content on the storage medium becomes no longer accessible. Then, by reference to the content's identification information that has been recorded on the storage medium, the count that is stored in the bound recording processing section is detected and is incremented by one.

By using such a counter, the permission information described for the first through third preferred embodiments can be expanded to multiple pieces. In addition, by storing the content's identification information on the storage medium, a sort of bidirectional move is realized as a check-in from the storage medium to the bound recording processing section.

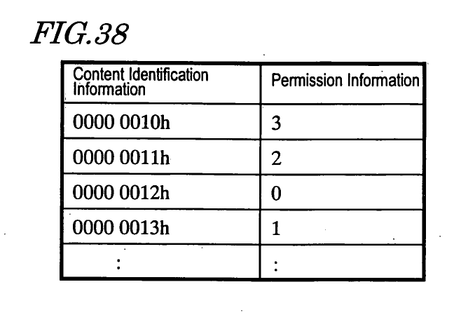

Hereinafter, an example in which the checkout/check-in method is applied to the configuration of the first preferred embodiment will be described. In that case, the configuration is basically the same as that shown in FIG. 3. However, since the “accessibility flag” shown in FIG. 12A defines only the two values of zero and one, a counter that can define more than two values needs to be used. A modified example of the accessibility information is shown in FIG. 38, for instance.

In FIG. 38, the accessibility information is shown as “permission information”. This is because the accessibility can be determined by judging whether the value is “non-zero” or “zero”. In this case, however, the values “1” and “2” that are included in “non-zero” also represent important information that shows the number of times the content can be accessed. That is why this permission information will be referred to herein as “accessibility count information” in the following description.

Next, it will be described with reference to FIGS. 3 and 38 how the recorder 101 operates according to this “checkout/check-in” method.

When a content bound-record request is received from the user, the setting section 1303 included in the encryption section 1201 of the bound recording processing section 103 generates accessibility count information associated with that content.

First, as a preparation, it is determined whether or not any illegal alterations have been done on the content. This decision processing step is just as already described for the first preferred embodiment except that the “accessibility count information” is used in place of the “permission information”. The current check value 1505 stored in the memory 106 and the check value generated by the checking section 1503 are compared to each other. If these two values do not agree with each other, abnormality processing is carried out. But if the two values agree with each other, the accessibility count information is available. Also, when the values agree with each other, bound recording processing is continued. At the time of the abnormality processing, the accessibility count information may be reset to its initial value.

In the processing that follows, the information generating section 1501 increments the current accessibility count by one and defines the information as the content identification information of the content to be newly bound-recorded. This information is sent to the content encrypting section 1302 (see FIG. 9). The accessibility count information at the address allocated to the new content identification information is set to a predetermined value (e.g., three). The predetermined value may either be provided by the content provider as content's auxiliary information along with the content itself or be a default value if no information is provided by the content provider.

The accessibility count information is newly added to, and retained in, the memory 106. The value of the check counter 1504 is also updated. The check value generating section 1502 generates a new check value based on the new accessibility count information and the value of the check counter and get it stored as the check value 1505 in the memory 106.

As a result of these processing steps, the content is bound-recorded and its permission information is generated.

Next, it will be described what processing is carried out when a content checkout request or a content playback request is received from the user. The recorder 101 receives the checkout request by way of the user interface section 112.

In each of these two types of processing, first, the content is checked for any illegal alterations that may have been done so far. This processing step is the same as the processing step to be carried out first in response to the bound-record request described above. The following processing is carried out only when it is determined that the accessibility count information has never been altered and is still effective.

In response to the checkout request, a list of contents that can be checked out is displayed on the user interface section 112. Then, on the content that has been designated as a content to check out by way of the user interface section 112, the control section 111 gets the checkout processing done by controlling the bound recording processing section 103, the recording section 108 and so on.

If the content has been copied onto the first storage medium 109 successfully as a result of this processing, then the information changing section 1506 decrements the content's accessibility count by one and stores it in the memory 106. In addition, the information changing section 1506 also updates the check counter 1504, and sends the updated count, along with the updated accessibility count, to the check value generating section 1507, thereby getting a new check value generated. Then, the information changing section 1506 stores the new check value in the memory 106, too.

If the first storage medium 109 protects the content by coding it, for example, information that makes the content on the first storage medium 109 accessible (e.g., information about a key to decode the content's code) is written on the storage medium 109 after the accessibility count information and the check value have been stored in the memory 106.

The content identification information may be a combination of the unique ID of the recorder 101 and the content identification information itself, for example.

If the content could not be copied onto the first storage medium 109 due some defect thereof, then the user would be notified of the abnormality processing and the processing responsive to the checkout request should be ended without changing the accessibility count information, the check counter value and the check value. In this manner, the checkout operation is finished.

In response to a check-in request, a list of contents that are currently stored on the first storage medium 109 and that can be checked in is displayed on the user interface section 112. In this case, by reference to the content identification information stored on the first storage medium 109, only contents, of which the content identification information includes the unique ID of the recorder 101, may be displayed selectively. Then, on the content that has been designated as a content to check in by way of the user interface section 112, the control section 111 gets the check-in processing done by controlling the bound recording processing section 103, the recording section 108 and so on. Specifically, the information changing section 1506 increments the content's accessibility count by one and stores it in the memory 106. In addition, the information changing section 1506 also updates the check counter 1504, and sends the updated count, along with the updated accessibility count, to the check value generating section 1507, thereby getting a new check value generated. Then, the information changing section 1506 stores the new check value in the memory 106, too.

If the first storage medium 109 protects the content by coding it, for example, information that makes the content on the first storage medium 109 accessible (e.g., information about a key to decode the content's code) is erased from the storage medium 109 before the accessibility count information and the check value are stored in the memory 106. Alternatively, the content itself may be erased. In this manner, the check-in operation is finished.

A data processor and processing method according to the present invention can not only bound-record a content using a dedicated device without being limited by the capacity of a bound recording medium, but also move the content to a medium, which is also playable with another device, while following the “copy one generation” content protection rule. Thus, the present invention is effectively applicable for use in a bound-recording storage device, for example.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Application No. 2004-365725 filed on Dec. 17, 2004, the entire contents of which are hereby incorporated by reference.

What is claimed is:

1. A data processor comprising:
a first medium on which a content's data has been bound-recorded;
a memory having stored thereon access control information to be used for controlling access to the content;
an interface section that receives a request concerning the access to the content; and
a read/write section for writing data on a second medium and reading the data that has been written on the second medium,
wherein if the interface section has received a request to back up the content, the read/write section writes the content's data on the second medium and the memory retains the access control information without modifying the information, and
wherein if the interface section has received a request to restore the content and if the access control information that makes the content accessible is stored in the memory and if the content's data has been written on the second medium, then the read/write section reads the content's data from the second medium and writes the data on the first medium.

2. The data processor of claim 1, further comprising a bound recording processing section for erasing data from the first medium,
wherein if the interface section has received a request to erase the content, the bound recording processing section erases the content's data and the memory retains the access control information without modifying the information.

3. The data processor of claim 2, further comprising a control section for changing details of the access control information,
wherein the bound recording processing section is able to read the data from the first medium, and
wherein if the interface section has received a request to move the content and if the access control information that makes the content accessible is stored in the memory, then the bound recording processing section reads the content's data from the first medium and outputs the data, and
the control section changes the access control information into information that does not permit access to the content and stores the information in the memory, and writes the content's data on either the second storage medium or on a third storage medium that is provided separately from the second storage medium.

4. The data processor of claim 2, wherein the content's data has been encrypted so as to be decodable with its own decoding information, and
wherein if the decoding information is stored as the access control information in the memory, then the read/write section reads the encrypted data from the second medium and writes the data on the first medium.

5. The data processor of claim 4, further comprising a control section for changing the details of the access control information,
wherein the bound recording processing section is able to read the data from the first medium, and
wherein if the interface section has received a request to move the content and if the decoding information is stored as the access control information in the memory, then the bound recording processing section reads the content's data from the first medium and outputs the data, and
the control section makes the decoding information not available, and writes the content's data either on the second storage medium or on a third storage medium that is provided separately from the second storage medium.

6. The data processor of claim 5, further comprising a decoding section for decoding the content's data in accordance with the decoding information,
wherein the content's data that has been decoded by the decoding section is written on the second storage medium and/or on the third storage medium that is provided separately from the second storage medium.

7. The data processor of claim 2, wherein if the interface section has received a request to bound-record a content, then the bound recording processing section generates access control information, which is associated with a new content and which makes the new content accessible, and writes the new content's data on the first medium.

8. The data processor of claim 1, wherein the content's data includes copy control information that prohibits re-copying.

9. The data processor of claim 1, wherein the memory has stored thereon access control information that specifies the accessibility count of a content, and
wherein if the interface section has received a request to check out the content and if access control information that shows that the accessibility count is at least one is stored in the memory, then the read/write section writes the content's data on the second medium and the memory stores access control information showing that the accessibility count has decreased by one, but
wherein if the interface section has received a request to check in the content, then the read/write section makes the content's data that has been written on the second medium not available, and the memory stores access control information showing that the accessibility count has increased by one.

10. The data processor of claim 9, further comprising a bound recording processing section for erasing data from the first medium,
wherein if the interface section has received a request to erase the content, the bound recording processing section erases the content's data and the memory retains the access control information without modifying the information.
